(19) United States
(12) Patent Application Publication
(10) Pub. No.: US 2026/0202717 A1
(43) Pub. Date: Jul. 16, 2026

(54) OPTICAL SYSTEM AND IMAGE PICKUP APPARATUS

(71) Applicant: CANON KABUSHIKI KAISHA, Tokyo (JP)

(72) Inventor: Takeo MORI, Tochigi (JP)

(21) Appl. No.: 19/415,899

(22) Filed: Dec. 11, 2025

(30) Foreign Application Priority Data
Jan. 16, 2025 (JP) 2025-005868

(51) Int. Cl. G03B 13/34; G02B 9/12

(52) U.S. Cl. CPC G03B 13/34; G02B 9/12

(57) ABSTRACT

An optical system includes, in order from an object side to an image side, a front group with negative refractive power including at least one lens unit, an intermediate lens unit with negative refractive power, and a rear group with positive refractive power including at least one lens unit. Each distance between adjacent lens units changes during focusing. The front group includes three negative lenses, consecutively arranged in this order from a position closest to an object to the image side. The intermediate lens unit moves toward the object side during focusing from infinity to a close distance. The front group includes at least two negative lenses and at least one positive lens. Predetermined inequalities are satisfied.

### BACKGROUND

### Field of the Technology

The aspect of the disclosure relates to one or more embodiments of an optical system and an image pickup apparatus.

### Description of Related Art

The optical systems for imaging require high-speed focusing (a lightweight focus lens unit). Japanese Patent Application Laid-Open No. 2023-167728 discloses an optical system consisting of, in order from the object side, a first lens unit with negative refractive power, a second lens unit that moves during focusing, and a third lens unit with positive refractive power that includes an aperture stop.

### SUMMARY

An optical system according to one aspect of the disclosure may include, in order from an object side to an image side, a front group with negative refractive power including at least one lens unit, an intermediate lens unit with negative refractive power, and a rear group with positive refractive power including at least one lens unit. Each distance between adjacent lens units changes during focusing. The front group includes three negative lenses, consecutively arranged in this order from a position closest to an object to the image side. The intermediate lens unit moves toward the object side during focusing from infinity to a close distance. The front group may include at least two negative lenses and at least one positive lens. The following inequalities may be satisfied:

$$1. \leq TTL / ( f \times tan ω ) \leq 9.$$

$$0.5 \leq - fm / f \leq 9.0$$

where f is a focal length of the optical system, ω is a maximum half angle of view of the optical system, TTL is a distance on an optical axis from a lens surface closest to an object of the optical system to a lens surface closest to an image plane of the optical system plus an air-equivalent distance on the optical axis from the lens surface closest to the image plane of the optical system to the image plane, and fm is a focal length of the intermediate lens unit. An image pickup apparatus having the above optical system also constitutes another aspect of the disclosure.

Features of the present disclosure will become apparent from the following description of embodiments with reference to the attached drawings. The following description of embodiments is described by way of example.

### BRIEF DESCRIPTION OF THE DRAWINGS

FIG. 1 is a sectional view of an optical system according to Example 1.

FIG. 2 is an aberration diagram of the optical system according to Example 1.

FIG. 3 is a sectional view of an optical system according to Example 2.

FIG. 4 is an aberration diagram of the optical system according to Example 2.

FIG. 5 is a sectional view of an optical system according to Example 3.

FIG. 6 is an aberration diagram of the optical system according to Example 3.

FIG. 7 is a sectional view of an optical system according to Example 4.

FIG. 8 is an aberration diagram of the optical system according to Example 4.

FIG. 9 is a sectional view of an optical system according to Example 5.

FIG. 10 is an aberration diagram of the optical system according to Example 5.

FIG. 11 is a sectional view of an optical system according to Example 6.

FIG. 12 is an aberration diagram of the optical system according to Example 6.

FIG. 13 is a sectional view of an optical system according to Example 7.

FIG. 14 is an aberration diagram of the optical system according to Example 7.

FIG. 15 is a sectional view of an optical system according to Example 8.

FIG. 16 is an aberration diagram of the optical system according to Example 8.

FIG. 17 is a sectional view of an optical system according to Example 9.

FIG. 18 is an aberration diagram of the optical system according to Example 9.

FIG. 19 is a sectional view of an optical system according to Example 10.

FIG. 20 is an aberration diagram of the optical system according to Example 10.

FIG. 21 is a sectional view of an optical system according to Example 11.

FIG. 22 is an aberration diagram of the optical system according to Example 11.

FIG. 23 is a sectional view of an optical system according to Example 12.

FIG. 24 is an aberration diagram of the optical system according to Example 12.

FIG. 25 is a sectional view of an optical system according to Example 13.

FIG. 26 is an aberration diagram of the optical system according to Example 13.

FIG. 27 is a sectional view of an optical system according to Example 14.

FIG. 28 is an aberration diagram of the optical system according to Example 14.

FIG. 29 is a sectional view of an optical system according to Example 15.

FIG. 30 is an aberration diagram of the optical system according to Example 15.

FIG. 31 is a sectional view of an optical system according to Example 16.

FIG. 32 is an aberration diagram of the optical system according to Example 16.

FIG. 33 is a sectional view of an optical system according to Example 17.

FIG. 34 is an aberration diagram of the optical system according to Example 17.

FIG. 35 is a sectional view of an optical system according to Example 18.

FIG. 36 is an aberration diagram of the optical system according to Example 18.

FIG. 37 is a sectional view of an optical system according to Example 19.

FIG. 38 is an aberration diagram of the optical system according to Example 19.

FIG. 39 is a sectional view of an optical system according to Example 20.

FIG. 40 is an aberration diagram of the optical system according to Example 20.

FIG. 41 is a sectional view of an optical system according to Example 21.

FIG. 42 is an aberration diagram of the optical system according to Example 21.

FIG. 43 illustrates an image pickup apparatus having the optical system according to any one of Examples 1 to 21.

### DESCRIPTION OF THE EMBODIMENTS

Referring now to the accompanying drawings, a description will be given of examples according to the disclosure.

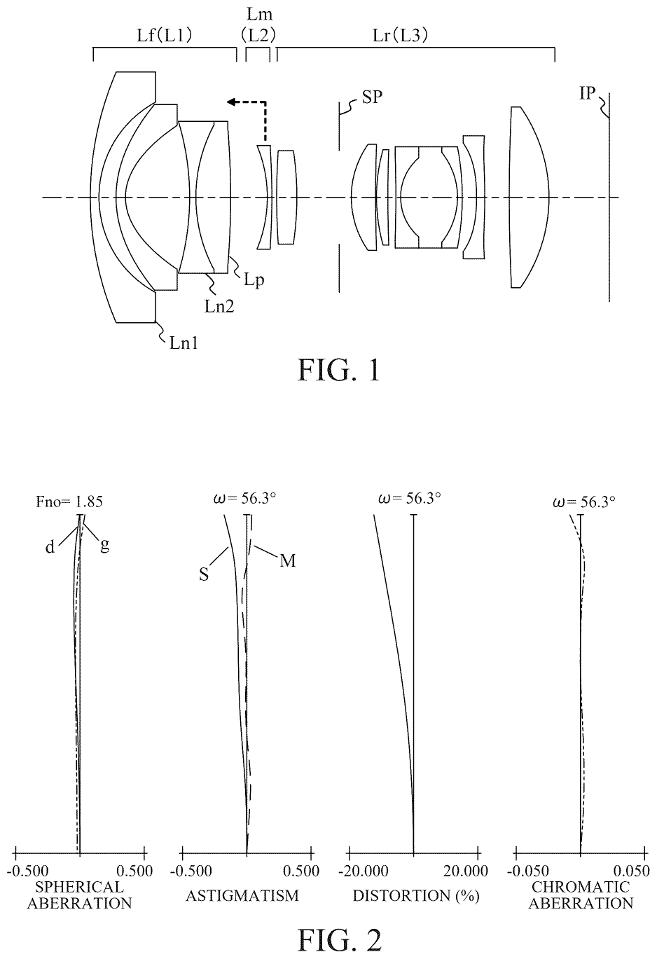

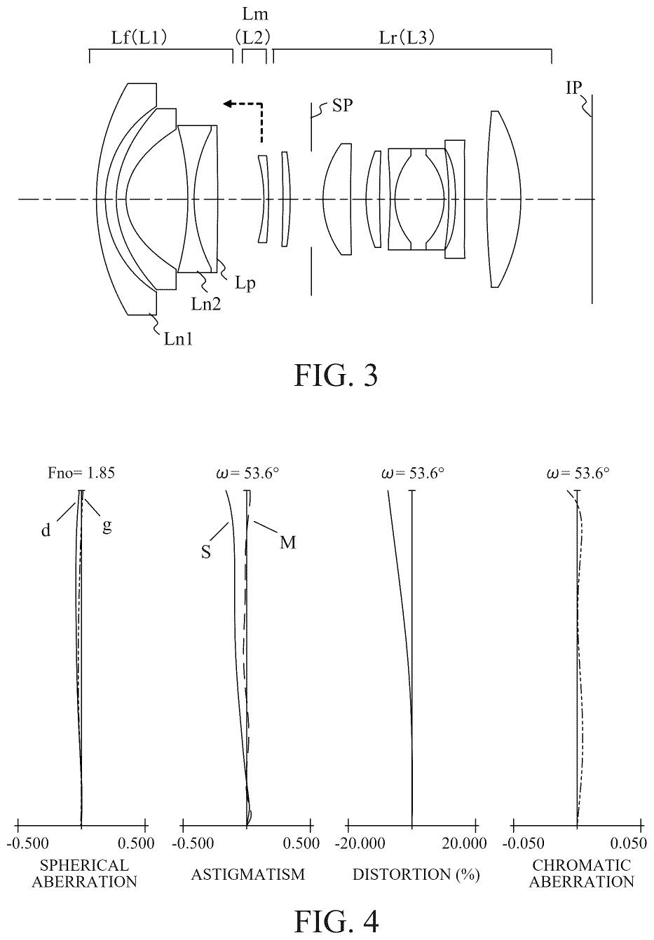

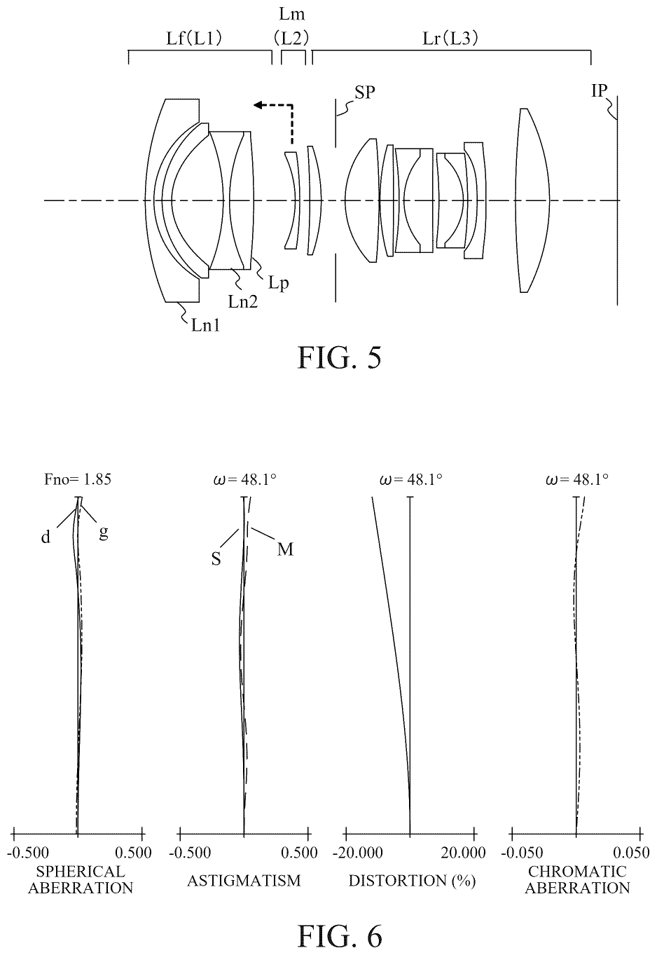

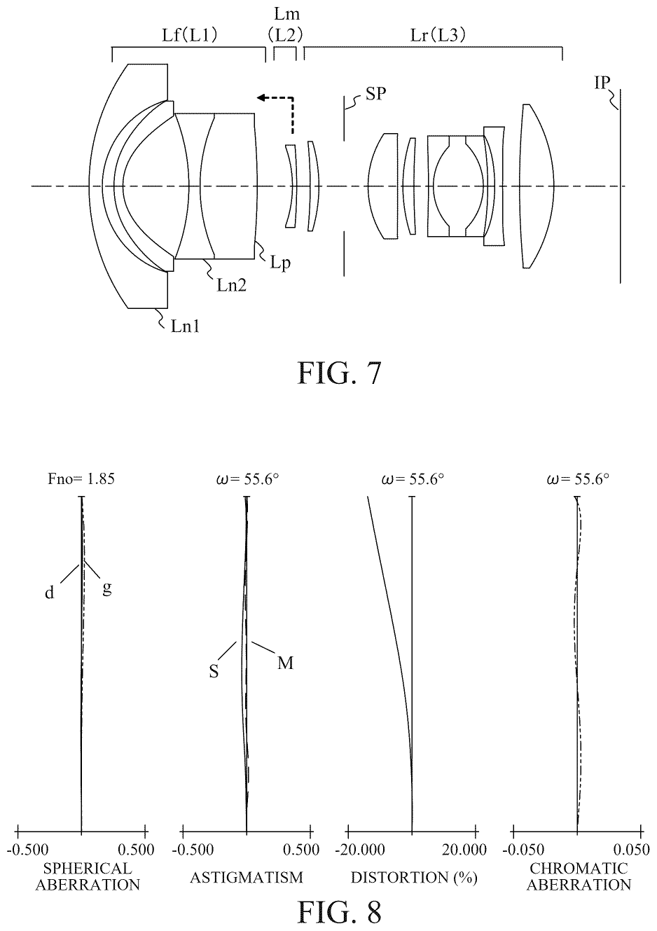

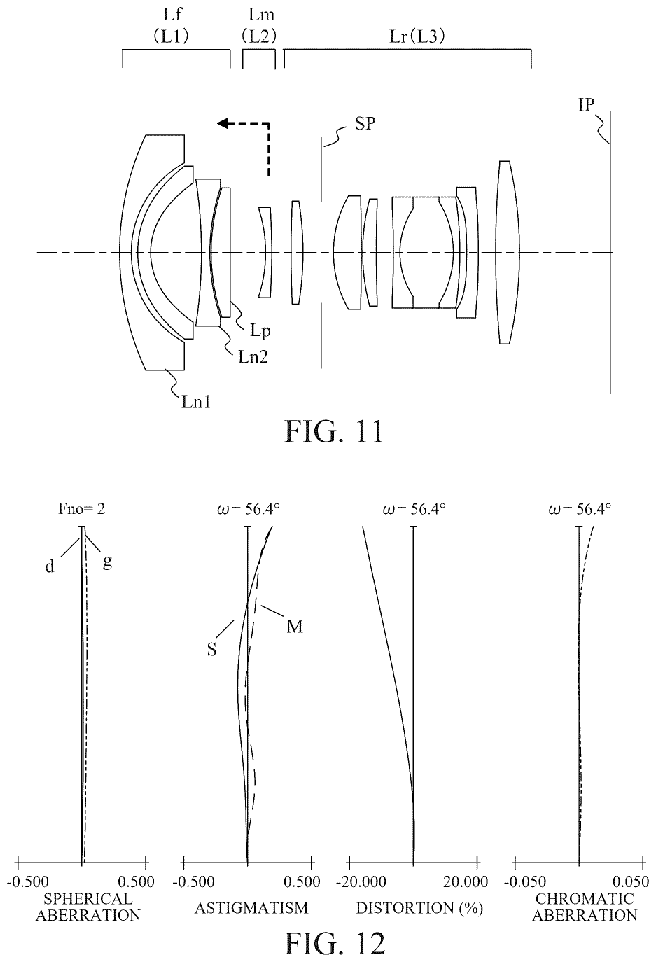

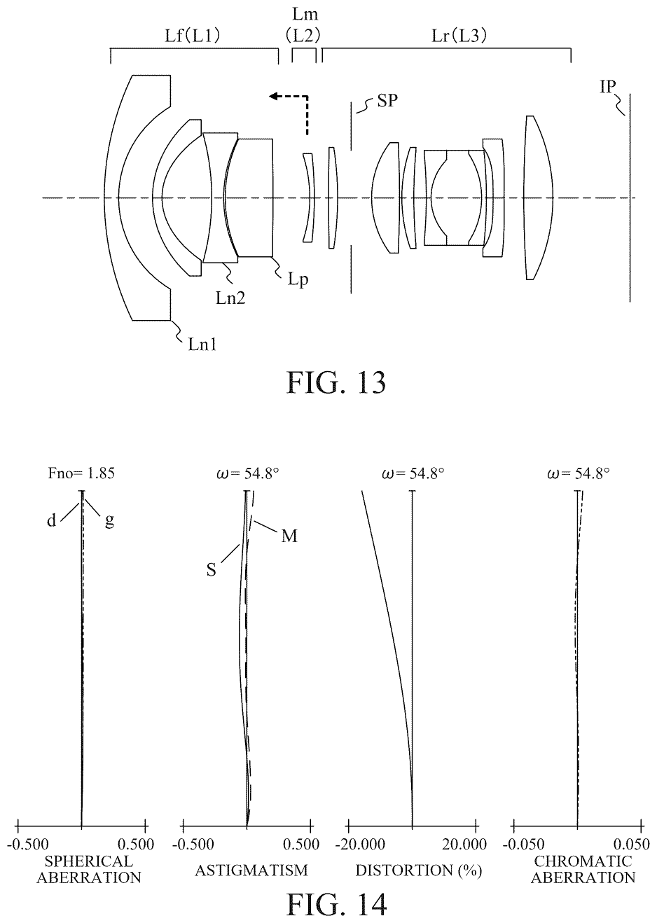

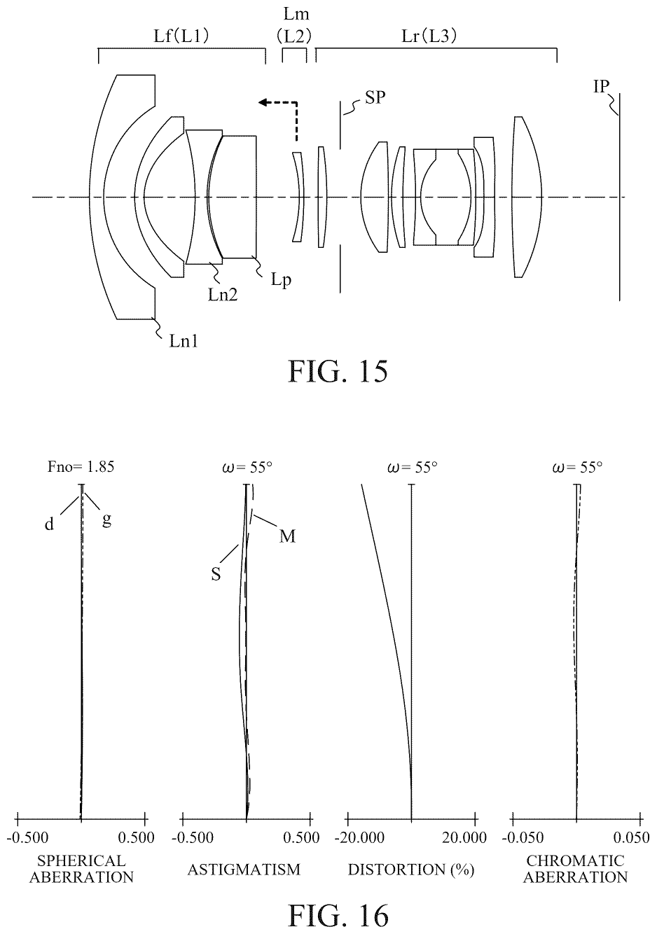

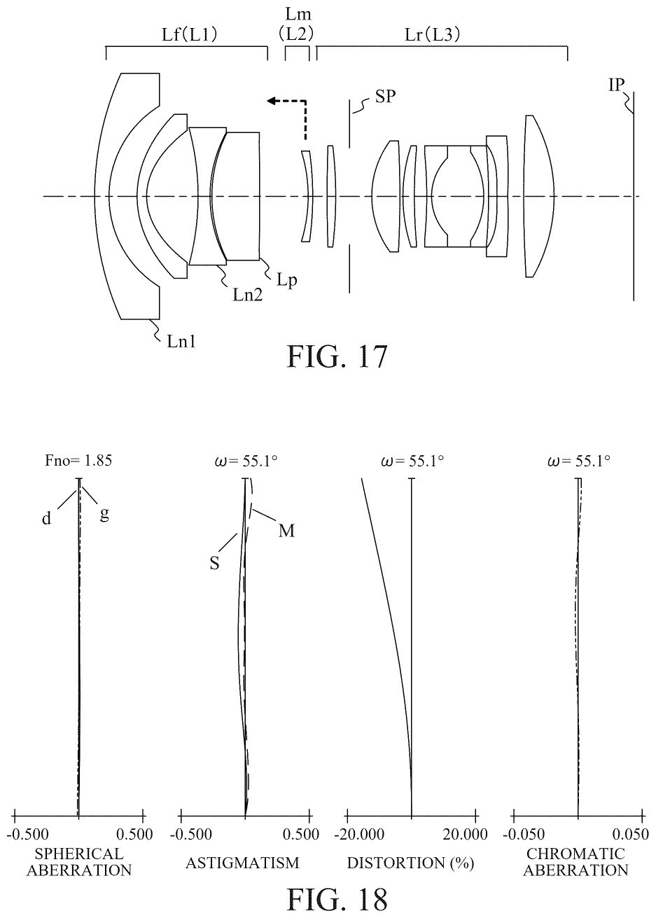

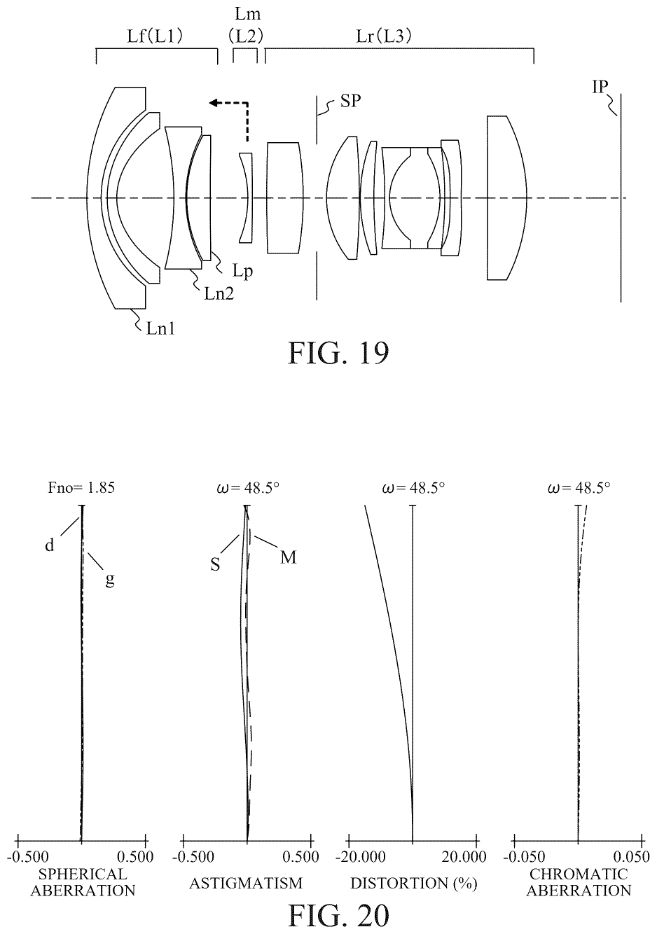

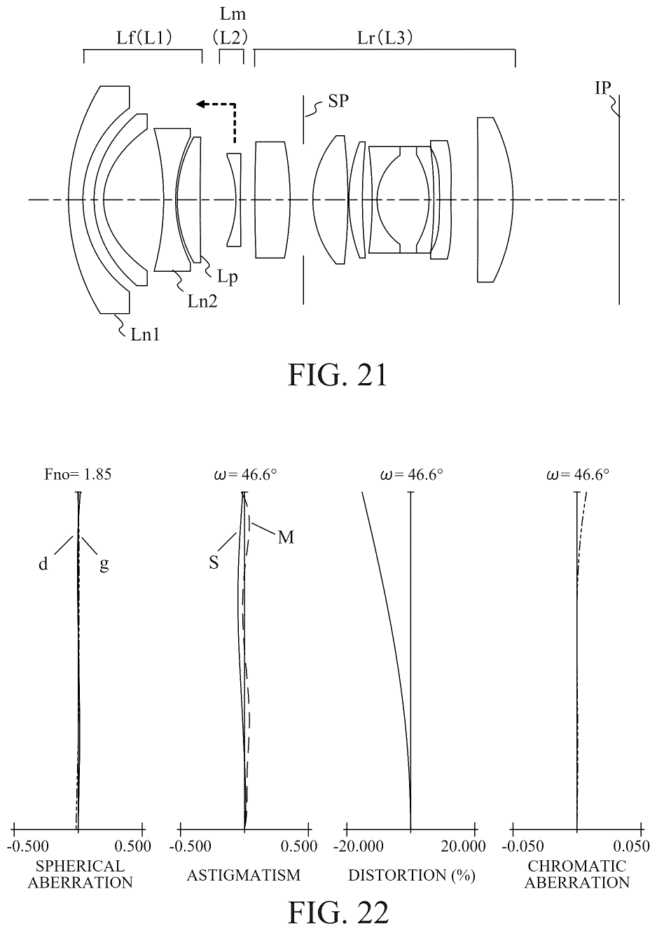

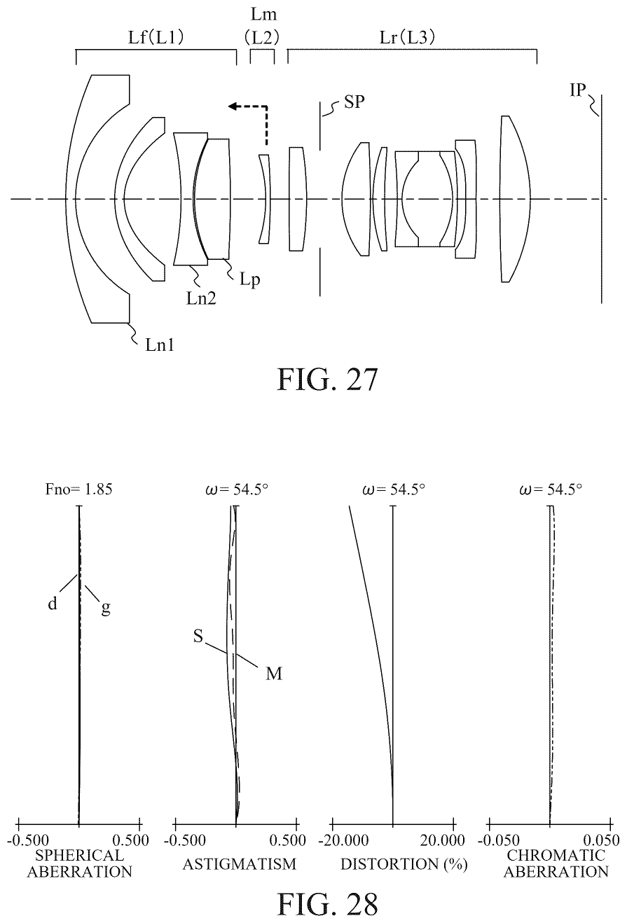

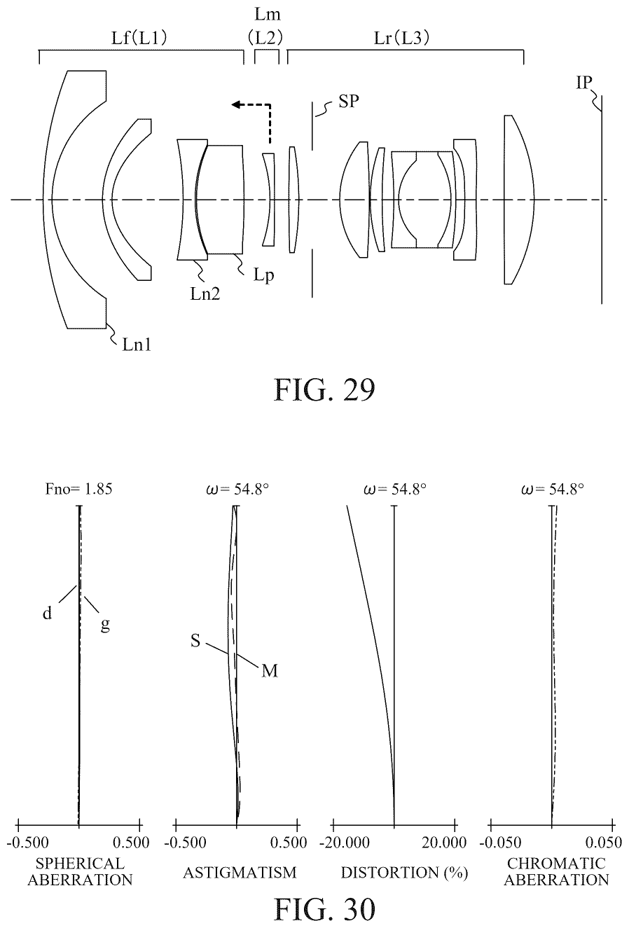

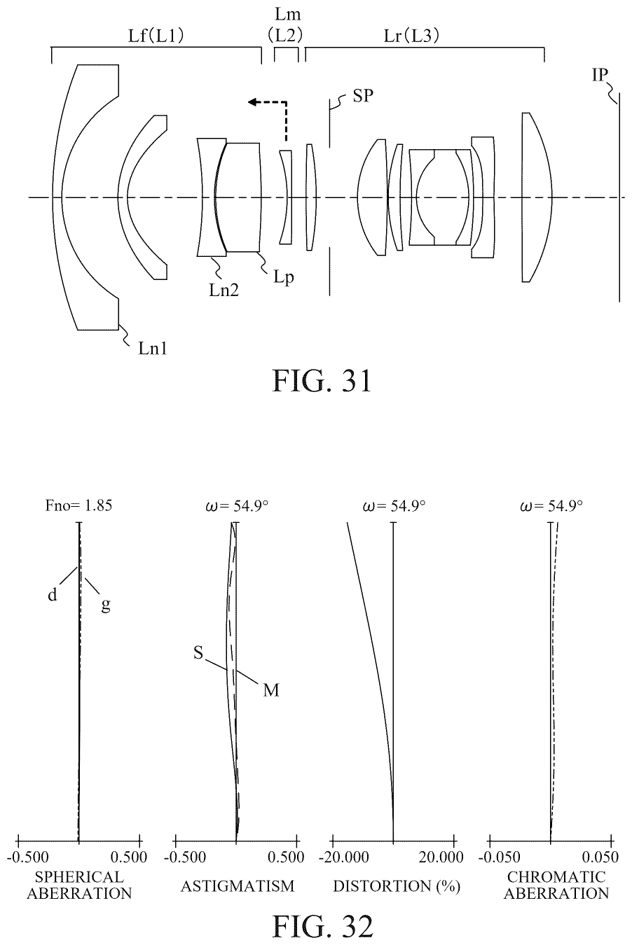

FIGS. 1, 3, 5, 7, 9, 11, 13, 15, 17, 19, 21, 23, 25, 27, 29, 31, 33, 35, 37, 39, and 41 illustrate cross-sections of optical systems according to Examples 1 to 21, respectively. In each figure, a left side is an object side (front side), and a right side is an image side (rear side).

First, before specific descriptions according to Examples 1 to 21 are provided, common aspects of each example will be explained. The optical system according to each example is used for a variety of image pickup apparatuses such as a digital video camera, a digital still camera, a broadcasting camera, a film-based camera, and a surveillance camera.

The optical system according to each example includes, in order from the object side to the image side, a front group Lf including at least one lens unit, an intermediate lens unit Lm, and a rear group Lr including at least one lens unit. A lens unit is a group of one or more lenses that move together or remain stationary during focusing. That is, each distance between adjacent lens units changes during focusing.

SP denotes an aperture stop and is included in the rear group Lr. IP denotes a paraxial image plane. The image plane IP is where the imaging surface (light receiving surface) of an image sensor such as a CCD sensor or CMOS sensor, or a film surface (photosensitive surface) of a silver film is placed.

A glass block without refractive power, such as a cover glass or an IR cut filter, may be placed between a lens surface closest to the image plane of the optical system and the image plane.

In the optical system according to each example, the front group Lf has negative refractive power as a whole, and the intermediate lens unit Lm has negative refractive power as a whole. The rear group Lr has positive refractive power as a whole. By adopting this retrofocus type power arrangement, the optical system has a wide angle. Refractive powers of the lens unit and the lens represent refractive powers in the paraxial region and correspond to the reciprocal of a focal length.

In each example of the optical system, the intermediate lens unit Lm moves toward the object side during focusing from infinity to a close distance. By moving the intermediate lens unit Lm, which is disposed in the intermediate portion where a light beam does not spread significantly, the weight of the intermediate lens unit Lm can be reduced as a focus lens unit. In each figure, the moving direction of the lens unit during focusing from infinity to a close distance is indicated by a broken arrow above the moving lens unit.

In each example of the optical system, the front group Lf has at least two negative lenses Ln1 and Ln2, and at least one positive lens Lp. The first negative lens Ln1 is disposed closest to the object of the front group Lf. This configuration can satisfactorily correct distortion and lateral chromatic aberration. The second negative lens Ln2 is disposed closer to the image plane than the first negative lens Ln1. The positive lens Lp is disposed closer to the image plane or object than the second negative lens Ln2. The number of lenses is considered to be two in a case where two lenses are cemented together to form a cemented lens.

The following inequality in a case where the optical system is a zoom lens capable of magnification variation may be satisfied:

$$1. \leq TTL / ( f \times tan ω ) \leq 9.0 \qquad ( 1 )$$

where f is a focal length of the entire optical system, ω is a maximum half angle of view of the optical system, and TTL is a length (overall optical length) obtained by adding the back focus to a distance on the optical axis (on-axis distance) from a lens surface closest to an object of the optical system to a lens surface closest to an image plane of the optical system on an optical axis. The back focus is an air-equivalent distance on the optical axis from a lens surface closest to the image plane of the optical system to the image plane.

Inequality (1) defines a proper relationship between the overall optical length and the image height of the optical system. In a case where TTL/(f×tan ω) becomes higher than the upper limit of inequality (1), the overall optical length increases, resulting in a larger optical system. In a case where the overall optical length is reduced such that TTL/(f×tan ω) becomes lower than the lower limit of inequality (1), the refractive power of each lens constituting the optical system becomes stronger, and it becomes difficult to correct distortion and lateral chromatic aberration.

The lower limit of inequality (1) may be replaced with 1.5, 2.0, 2.5, 3.0, or 3.4. The upper limit of inequality (1) may be replaced with 8.5, 8.0, 7.5, or 7.0.

In each example, the optical system may satisfy the following inequality (2):

$$0.5 \leq - fm / f \leq 9.0 \qquad ( 2 )$$

where fm is a focal length of the intermediate lens unit Lm (f>0, fm<0).

Inequality (2) defines a proper relationship between the focal length of the intermediate lens unit Lm and the focal length of the entire optical system. In a case where the refractive power of the intermediate lens unit Lm becomes weaker such that −fm/f becomes higher than the upper limit of inequality (2), the moving amount of the intermediate lens unit Lm during focusing increases, and the overall optical length increases. In a case where the refractive power of the intermediate lens unit Lm becomes stronger such that −fm/f becomes lower than the lower limit of inequality (2), the aberration variation associated with focusing increases.

The lower limit of inequality (2) may be replaced with 0.7, 1.0, 1.2, or 1.3. The upper limit of inequality (2) may be replaced with 8.5, 8.0, 7.5, or 7.0. Satisfying at least one of the above configurations and inequalities (1) and (2) can achieve an optical system that has a reduced size, high optical performance, and high-speed focusing ability.

The optical system according to each example may satisfy at least one of the following inequalities (3) to (12).

The optical system according to each example may satisfy the following inequality (3):

$$- 1. \leq ( R 12 - R 11 ) / ( R 11 + R 12 ) < 0.0 \qquad ( 3 )$$

where R11 is a radius of curvature of an object-side lens surface of the first negative lens Ln1, and R12 is a radius of curvature of an image-side lens surface of the first negative lens Ln1.

Inequality (3) defines a proper shape (shape factor) of the first negative lens Ln1. In a case where the shape factor of the first negative lens Ln1 becomes higher than the upper limit of inequality (3), a lens surface on the object side of the first negative lens Ln1 becomes concave, and it becomes difficult to properly correct both curvature of field and distortion. In a case where the shape factor of the first negative lens Ln1 becomes lower than the lower limit of inequality (3), a radius of curvature of the image-side lens surface of the first negative lens Ln1 reduces, and it becomes difficult to properly correct both curvature of field and distortion.

The lower limit of inequality (3) may be replaced with −0.9, −0.8, or −0.7. The upper limit of inequality (3) may be replaced with −0.05 or −0.1.

The optical system according to each example may satisfy the following inequality (4):

$$- 1. \leq ( R 21 + R 22 ) / ( R 22 - R 21 ) \leq 1. \qquad ( 4 )$$

where R21 is a radius of curvature of an object-side lens surface of the second negative lens Ln2, and R22 is a radius of curvature of an image-side lens surface of the second negative lens Ln2.

Inequality (4) defines a proper shape (shape factor) of the second negative lens Ln2. In a case where the shape factor of the second negative lens Ln2 becomes higher than the upper limit or becomes lower than the lower limit of inequality (4), the second negative lens Ln2 becomes a meniscus shape, and it becomes difficult to correct lateral chromatic aberration.

The lower limit of inequality (4) may be replaced with −0.9, −0.8, or −0.7. The upper limit of inequality (4) may be replaced with 0.5, 0.3, or 0.2.

The optical system according to each example may satisfy the following inequality (5):

$$- 1. \leq ( R p 1 + Rp 2 ) / ( Rp 2 - Rp 1 ) \leq 30.0 \qquad ( 5 )$$

where Rp1 is a radius of curvature of the object-side lens surface of the positive lens Lp, and Rp2 is a radius of curvature of the image-side lens surface of the positive lens Lp.

Inequality (5) defines a proper shape (shape factor) of the positive lens Lp. In a case where the shape factor of the positive lens Lp becomes higher than the upper limit of inequality (5), the lens surface on the image side of the positive lens Lp becomes concave with a small radius of curvature, and it becomes difficult to correct lateral chromatic aberration. In a case where the shape factor of the positive lens Lp becomes lower than the lower limit of inequality (5), the lens surface on the object side of the positive lens Lp becomes concave, and it becomes difficult to correct longitudinal chromatic aberration and spherical aberration.

The lower limit of inequality (5) may be replaced with −0.8, −0.5, 0.0, or 0.1. The upper limit of inequality (5) may be replaced with 25.0, 20.0, 15.0, or 10.0.

The optical system according to each example may satisfy the following inequality (6):

$$0. < β m \leq 1. \qquad ( 6 )$$

where βm is a lateral magnification of the intermediate lens unit Lm in an in-focus state on an object at infinity (“in-focus state at infinity”).

Inequality (6) defines a proper lateral magnification of the intermediate lens unit Lm. In a case where the negative refractive power of the intermediate lens unit Lm weakens such that Bm becomes higher than the upper limit of inequality (6), the moving amount of the intermediate lens unit Lm during focusing increases, and the overall optical length increases. In a case where the negative refractive power of the intermediate lens unit Lm strengthens such that Bm becomes lower than the lower limit of inequality (6), the aberration fluctuation during focusing increases.

The lower limit of inequality (6) may be replaced with 0.02, 0.03, or 0.04. The upper limit of inequality (6) may be replaced with 0.95, 0.9, or 0.85.

In each example, the optical system may satisfy the following inequality (7):

$$40 \leq v d n \leq 90 \qquad ( 7 )$$

where νdn is an average value of Abbe numbers based on the d-line of all negative lenses included in the front group Lf.

Inequality (7) defines a proper Abbe number of all negative lenses in the front group Lf. In a case where νdn becomes higher than the upper limit of inequality (7), the refractive index of the usable glass material becomes low, a radius of curvature of each negative lens reduces, and it becomes difficult to correct coma and astigmatism. In a case where νdn becomes lower than the lower limit of inequality (7), the dispersion of chromatic aberration increases, and it becomes difficult to correct lateral chromatic aberration.

The lower limit of inequality (7) may be replaced with 42, 45, 48, or 50. The upper limit of inequality (7) may be replaced with 88, 85, 82, or 80.

In each example, the optical system may satisfy the following inequality (8):

$$0.5 \leq ( R m 1 + Rm 2 ) / ( Rm 2 - Rm 1 ) \leq 30.0 \qquad ( 8 )$$

where Rm1 is a radius of curvature of the lens surface closest to the object of the intermediate lens unit Lm, and Rm2 is a radius of curvature of the lens surface closest to the image plane of the intermediate lens unit Lm.

Inequality (8) defines a proper shape (shape factor) of the intermediate lens unit Lm. In a case where the shape factor of the intermediate lens unit Lm becomes higher than the upper limit of inequality (8), the radii of curvature of the object-side and image-side lens surfaces of the intermediate lens unit Lm become closer to each other, and the negative refractive power weakens. A moving amount of the intermediate lens unit Lm during focusing increases. In a case where the shape factor of the intermediate lens unit Lm becomes lower than the lower limit of inequality (8), the image-side lens surface of the intermediate lens unit Lm becomes concave with a small radius of curvature, and the variation in spherical aberration accompanying focusing increases.

The lower limit of inequality (8) may be replaced with 0.6, 0.7, or 0.8. The upper limit of inequality (8) may be replaced with 25.0, 20.0, 15.0, 10.0, or 8.0.

The following inequality (9) may be satisfied:

$$0.01 \leq Dm / Df \leq 1. \qquad ( 9 )$$

where Df is a distance on the optical axis between a lens surface closest to the image plane of the front group Lf and a lens surface closest to the object of the intermediate lens unit Lm in the in-focus state at infinity, and Dm is a distance on the optical axis between the image-side lens surface of the intermediate lens unit Lm and the object-side lens surface of the rear group Lr in the in-focus state at infinity.

Inequality (9) defines a proper relationship between the distances between the intermediate lens unit Lm and the front group Lf and the rear group Lr. In a case where Dm/Df becomes higher than the upper limit of inequality (9), the distance between the front group Lf and the intermediate lens unit Lm reduces, and it becomes difficult to secure the moving amount of the intermediate lens unit Lm during focusing. In a case where Dm/Df becomes lower than the lower limit of inequality (9), the distance between the front group Lf and the intermediate lens unit Lm increases, and the overall optical length increases.

The lower limit of inequality (9) may be replaced with 0.03, 0.05, 0.07, or 0.10. The upper limit of inequality (9) may be replaced with 0.90, 0.80, 0.70, or 0.60.

In each example, the optical system may satisfy the following inequality (10):

$$- 2.00 \leq f / ff \leq - 0.01 \qquad ( 10 )$$

where ff is a focal length of the front group Lf (ff<0).

Inequality (10) defines a proper relationship between the focal length of the front group Lf and the focal length of the entire optical system. In a case where the negative refractive power of the front group Lf weakens such that f/ff becomes higher than the upper limit of inequality (10), the pincushion distortion increases due to the retrofocus type power arrangement, and it becomes difficult to properly correct both curvature of field and distortion. In a case where the negative refractive power of the front group Lf strengthens such that f/ff becomes lower than the lower limit of inequality (10), the optical system becomes close to a telecentric system on the image side, and the overall optical length increases.

The lower limit of inequality (10) may be replaced with −0.18, −1.50, or −1.20. The upper limit of inequality (10) may be replaced with −0.02, −0.03, or −0.04.

The optical system according to each example may satisfy the following inequality (11):

$$0.1 \leq fr / f \leq 6.0 \qquad ( 11 )$$

where fr is a focal length of the rear group Lr (fr>0).

Inequality (11) defines a ratio of the focal length of the rear group Lr to the focal length of the entire optical system. In a case where the refractive power of the rear group Lr becomes weaker such that fr/f becomes higher than the upper limit of inequality (11), it becomes difficult to correct pincushion distortion and suppress an incident angle on the image plane. In a case where the refractive power of the rear group Lr becomes stronger such that fr/f becomes lower than the lower limit of inequality (11), the optical system becomes close to a telecentric system on the image side, and the overall optical length increases.

The lower limit of inequality (11) may be replaced with 0.3, 0.5, 0.8, or 1.0. The upper limit of inequality (11) may be replaced with 5.7, 5.5, 5.3, 5.0, or 4.7.

The optical system according to each example may satisfy the following inequality (12):

$$0.9 \leq Fno \leq 5.6 \qquad ( 12 )$$

where Fno is a minimum F-number in the in-focus state at infinity.

Inequality (12) defines a proper minimum F-number of the optical system. In a case where Fno falls outside the range of inequality (12), the proper brightness of the optical system cannot be secured.

The lower limit of inequality (12) may be replaced with 1.0, 1.1, or 1.2. The upper limit of inequality (12) may be replaced with 5.0, 4.5, 4.0, 3.5, or 3.2.

The optical system according to each example may satisfy at least one of the following configurations. In the optical systems according to each example, the first lens unit L1 with negative refractive power may be disposed closest to the object in order to approximate a retrofocus type power arrangement. In this case, in order to suppress an increase in the size of the focusing mechanism, the first lens unit L1 may be fixed (stationary) relative to the image plane during focusing.

In the optical system according to each example, a lens with positive refractive power may be disposed closest to the image plane in order to approximate a retrofocus type power arrangement.

In the optical system according to each example, in order to reduce the size and weight of the intermediate lens unit Lm as a focus lens unit, the intermediate lens unit Lm may consist of a single negative lens.

The optical systems according to Examples 1 to 21 will be specifically described below.

In the optical systems according to Examples 1 to 4 illustrated in FIGS. 1, 3, 5, and 7, the front group Lf (first lens unit L1) consists of, in order from the object side, a first negative lens Ln1, a negative lens, and a cemented lens of a second negative lens L2 and a positive lens Lp. The intermediate lens unit Lm (second lens unit L2) consists of a single negative lens. The rear group Lr consists of a single third lens unit L3 and has a positive lens closest to the image plane.

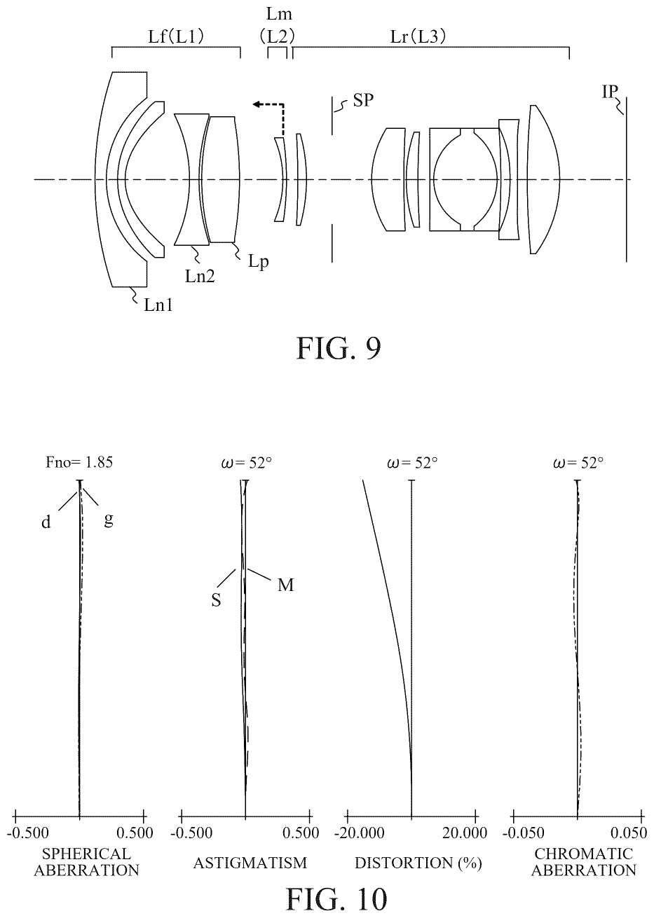

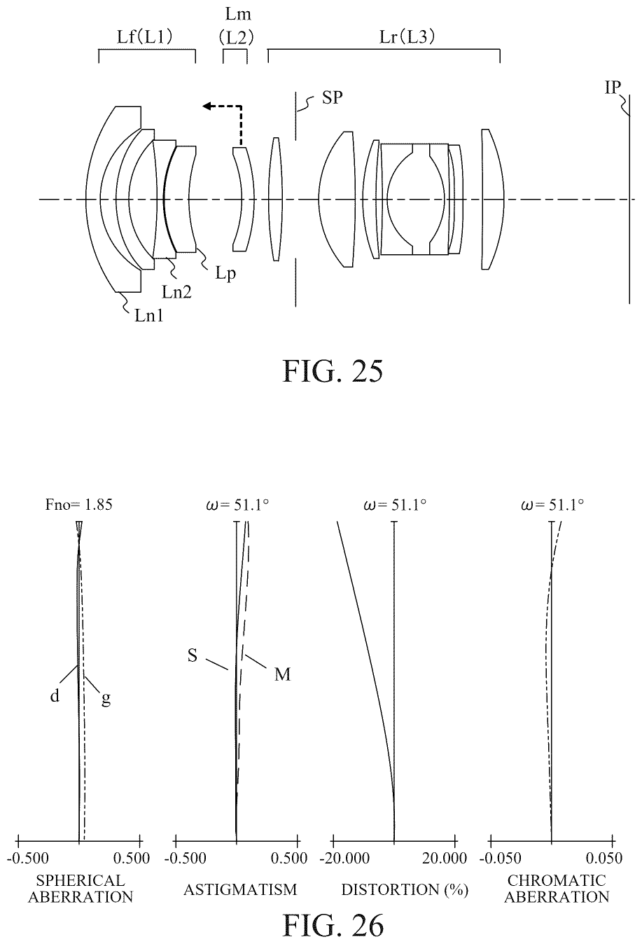

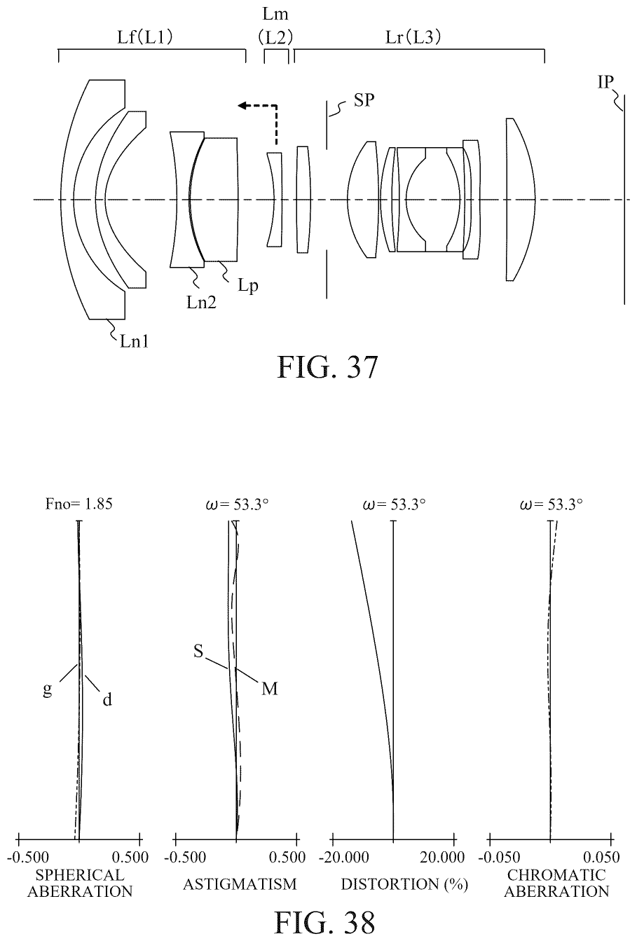

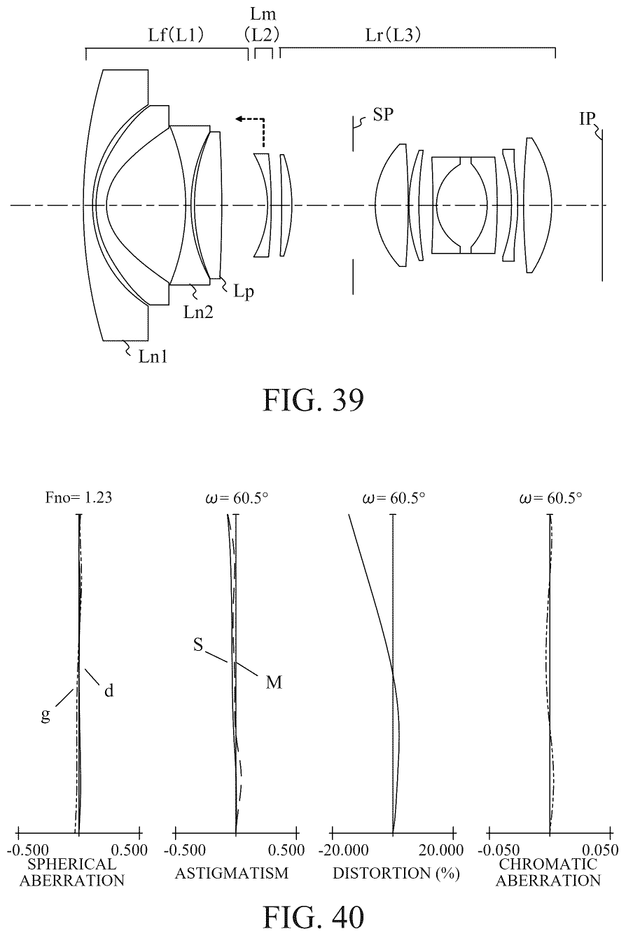

In the optical systems according to Examples 5 to 11 illustrated in FIGS. 9, 11, 13, 15, 17, 19, and 21, and Examples 13 to 16 illustrated in FIGS. 25, 27, 29, and 31, and Examples 19 and 20 illustrated in FIGS. 37 and 39, the front group Lf (first lens unit L1) consists of, in order from the object side, a first negative lens Ln1, a negative lens, a second negative lens L2, and a positive lens Lp. The intermediate lens unit Lm (second lens unit L2) consists of a single negative lens. The rear group Lr consists of a single third lens unit L3, and has a positive lens closest to the image plane.

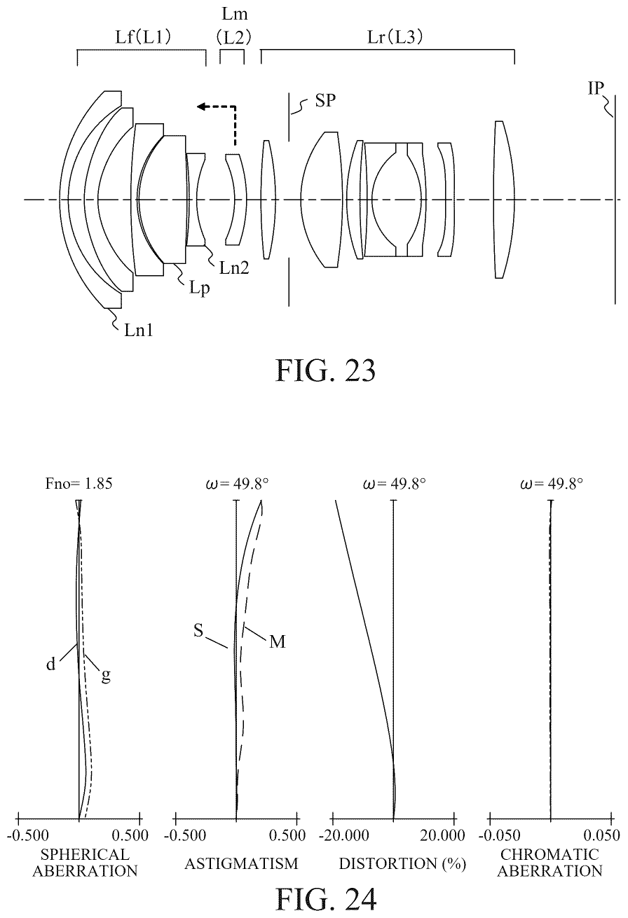

In the optical system according to Example 12 illustrated in FIG. 23, the front group Lf (first lens unit L1) consists of, in order from the object side, a first negative lens Ln1, a negative lens, a negative lens, a positive lens Lp, and a second negative lens L2. The intermediate lens unit Lm (second lens unit L2) consists of a single negative lens. The rear group Lr consists of a single third lens unit L3, and has a positive lens closest to the image plane.

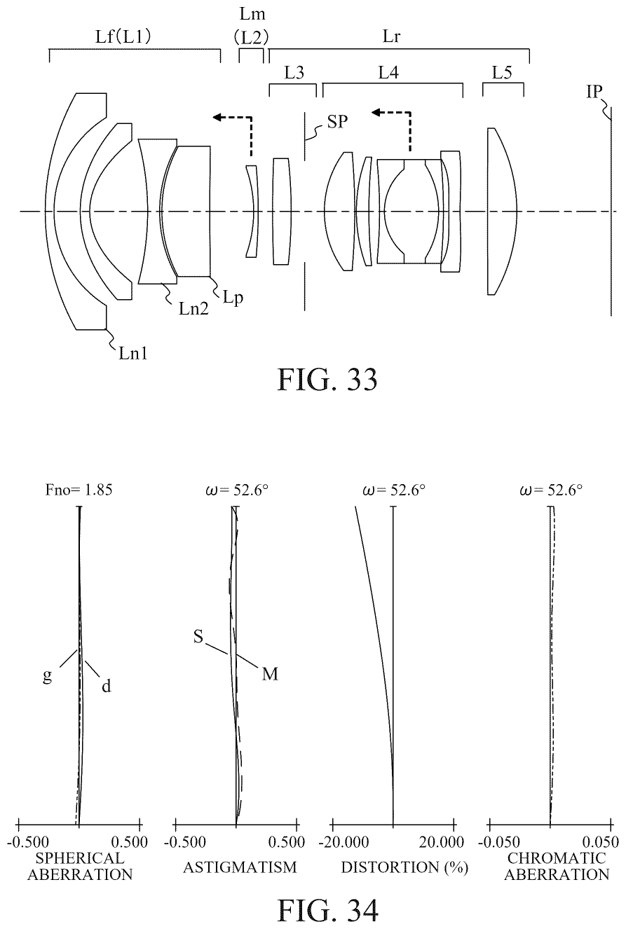

In the optical system according to Example 17 illustrated in FIG. 33, the front group Lf (first lens unit L1) consists of, in order from the object side, a first negative lens Ln1, a negative lens, a second negative lens L2, and a positive lens Lp. The intermediate lens unit Lm (second lens unit L2) consists of one negative lens. The rear group Lr consists of the third lens unit L3, the fourth lens unit L4, and the fifth lens unit L5, and has a positive lens closest to the image plane. The fourth lens unit L4 moves toward the object side during focusing from infinity to a close distance.

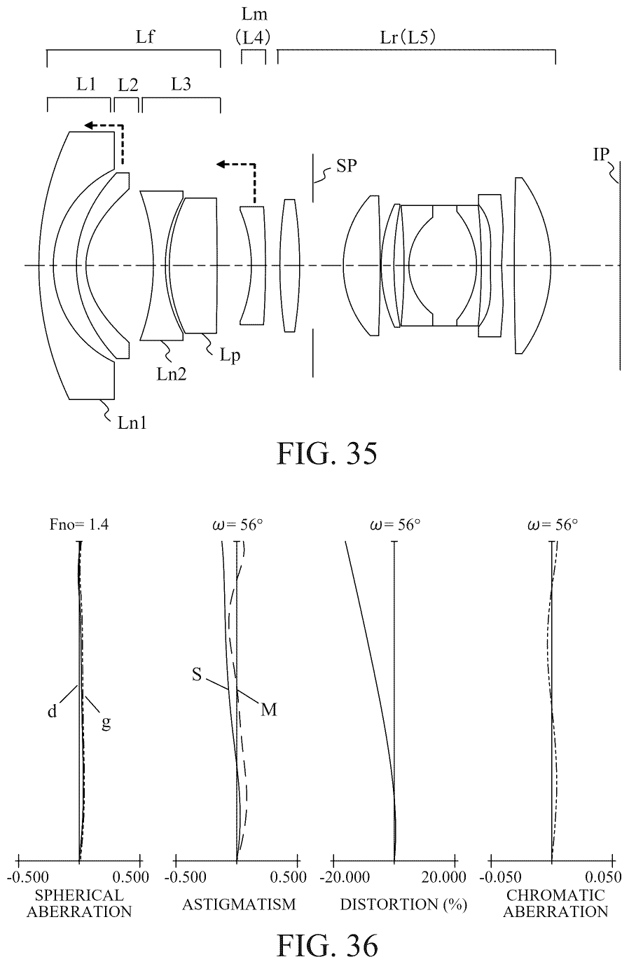

In the optical system according to Example 18 illustrated in FIG. 35, the front group Lf consists of, in order from the object side, the first lens unit L1, which consists of a first negative lens Ln1, the second lens unit L2, which consists of a negative lens, and the third lens unit L3, which consists of a second negative lens L2 and a positive lens Lp. The second lens unit L2 moves toward the object side during focusing from infinity to a close distance. The intermediate lens unit Lm (fourth lens unit L2) consists of one negative lens. The rear group Lr consists of one fifth lens unit L5 and has a positive lens closest to the image plane.

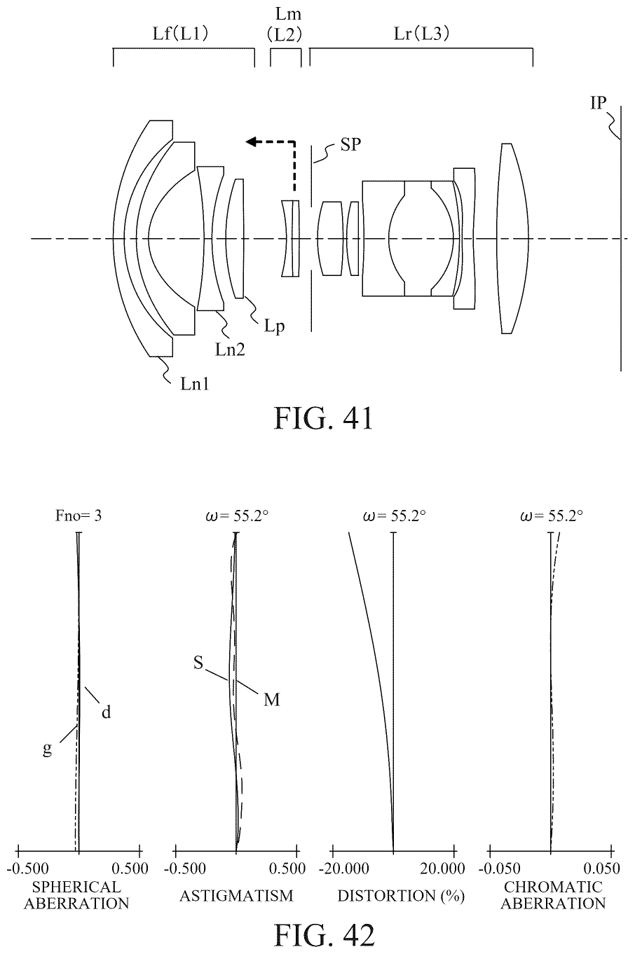

In the optical system according to Example 21 illustrated in FIG. 41, the front group Lf (first lens unit L1) consists of, in order from the object side, a first negative lens Ln1, a negative lens, a second negative lens L2, and a positive lens Lp. The intermediate lens unit Lm (second lens unit L2) consists of a cemented lens of a negative lens and a positive lens. The rear group Lr consists of one third lens unit L3 and has a positive lens closest to the image plane.

The following illustrates numerical examples 1 to 21 corresponding to Examples 1 to 21, respectively. In surface data of each numerical example, a surface number i indicates the order of the optical surface counted from the object side. r represents a radius of curvature (mm) of the i-th surface, and d represents a lens thickness or air gap (mm) on the optical axis between i-th and (i+1)-th surfaces. nd represents a refractive index for the d-line of an optical element between i-th and (i+1)-th surfaces, and νd represents an Abbe number of an optical element based on the d-line. The Abbe number νd based on the d-line is expressed as follows:

$$vd = ( Nd - 1 ) / ( NF - NC )$$

where Nd, NF, and NC are refractive indices for the d-line (587.56 nm), F-line (486.13 nm), and C-line (656.27 nm) in the Fraunhofer lines, respectively.

The effective diameter is a diameter (mm) of an area on the i-th lens surface through which the rays contributing to imaging pass.

The focal length (mm), F-number, and half angle of view (°) are all values for the optical system in the in-focus state at infinity for each numerical example. The half angle of view is a maximum half angle of view of the optical system. The overall lens length is an overall optical length TTL (mm) described above, and BF represents the back focus (mm) described above.

An asterisk “*” attached to a surface number indicates that the surface has an aspherical shape. The aspherical shape is expressed by the following equation:

$$X = \frac{( 1 / R ) {H}^{2}}{1 + \sqrt{1 - ( 1 + k ) {( H / R )}^{2}}} + A 3 \cdot {\vert H \vert}^{3} + A 4 \cdot {\vert H \vert}^{4} + A 5 \cdot {\vert H \vert}^{5} + A 6 \cdot {\vert H \vert}^{6} + A 7 \cdot {\vert H \vert}^{7} + A 8 \cdot {\vert H \vert}^{8} + A 9 \cdot {\vert H \vert}^{9} + A 10 \cdot {\vert H \vert}^{10} + A 11 \cdot {\vert H \vert}^{11} + A 12 \cdot {\vert H \vert}^{12} + A 13 \cdot {\vert H \vert}^{13} + A 14 \cdot {\vert H \vert}^{14}$$

where X is a displacement amount from a surface vertex in the optical axis direction, H is a height from the optical axis in a direction orthogonal to the optical axis, a light traveling direction is positive, R is a paraxial radius of curvature, K is a conic constant, and A3 to A14 are aspherical coefficients. “e±x” in the conic constant and aspherical coefficients means×10^{±x}.

NUMERICAL EXAMPLE 1
UNIT: mm
SURFACE DATA

| | | | | | Effective |
|---|---|---|---|---|---|
| Surface No. | r | d | nd | νd | Diameter |
| 1 | 65.261 | 1.80 | 1.72916 | 54.7 | 49.89 |
| 2 | 22.391 | 3.55 | | | 37.56 |
| 3* | 22.501 | 2.00 | 1.53110 | 55.9 | 36.80 |
| 4* | 10.890 | 13.42 | | | 29.87 |
| 5 | −53.904 | 1.30 | 1.49700 | 81.7 | 29.50 |
| 6 | 31.665 | 7.26 | 2.00100 | 29.1 | 28.06 |
| 7 | −170.929 | (Variable) | | | 26.65 |
| 8 | −27.852 | 0.95 | 1.59551 | 39.2 | 19.62 |
| 9 | −150.734 | (Variable) | | | 18.96 |
| 10 | 139.988 | 4.24 | 1.85150 | 40.8 | 18.12 |
| 11 | −65.064 | 8.86 | | | 18.24 |
| 12 (SP) | ∞ | 2.50 | | | 19.44 |
| 13 | 18.966 | 5.08 | 1.49700 | 81.7 | 20.12 |
| 14 | 302.519 | 0.20 | | | 19.37 |
| 15 | 36.344 | 2.38 | 1.90043 | 37.4 | 18.79 |
| 16 | 253.349 | 1.68 | | | 18.14 |
| 17 | −249.226 | 1.00 | 1.72342 | 38.0 | 16.87 |
| 18 | 10.762 | 11.88 | 1.59282 | 68.6 | 15.28 |
| 19 | −14.861 | 1.00 | 1.92286 | 20.9 | 17.56 |
| 20 | −55.116 | 2.99 | | | 19.24 |
| 21* | −40.771 | 1.70 | 1.53110 | 55.9 | 20.52 |
| 22* | −192.389 | 5.14 | | | 23.82 |
| 23 | 373.650 | 8.30 | 1.94594 | 18.0 | 33.95 |
| 24 | −32.440 | 35.68 | | | |
| Image Plane | ∞ | | | | |

ASPHERIC DATA
3rd Surface
K = 0.00000e+00 A 4 = −6.63796e−06 A 6 = −6.70307e−08
A 8 = 1.62682e−10 A10 = −2.22192e−13
4th Surface
K = −1.26367e+00 A 4 = 5.39505e−05 A 6 = −1.58869e−07
A 8 = 3.69399e−10 A10 = −4.45172e−13
21st Surface
K = 0.00000e+00 A 4 = −9.21608e−05 A 6 = 2.28848e−07
A 8 = −7.30417e−10
22nd Surface
K = 0.00000e+00 A 4 = −1.90938e−05 A 6 = 3.36972e−07
A 8 = −8.12350e−10

VARIOUS DATA

| | |
|---|---|
| Focal Length | 14.42 |
| Fno | 1.85 |
| Half Angle of View (°) | 56.32 |
| Image Height | 21.64 |
| Overall Lens Length | 108.50 |
| BF | 12.62 |

| Object Distance/Magnification | Infinity | 0.14 Times |
|---|---|---|
| d7 | 7.67 | 4.37 |
| d9 | 1.00 | 4.29 |
| Entrance Pupil Position | 18.88 | |
| Exit Pupil Position | −149.28 | |
| Front Principal-Point Position | 32.02 | |
| Rear Principal-Point Position | −1.80 | |

LENS UNIT DATA

| | | | | Front | Rear |
|---|---|---|---|---|---|
| | | | Lens | Principal- | Principal- |
| Lens | Starting | Focal | Configuration | Point | Point |
| Unit | Surface | Length | Length | Position | Position |
| 1 | 1 | −41.18 | 29.32 | −4.78 | −36.15 |
| 2 | 8 | −57.54 | 0.95 | −0.14 | −0.73 |
| 3 | 10 | 34.79 | 56.93 | 38.91 | −52.31 |

NUMERICAL EXAMPLE 2
UNIT: mm
SURFACE DATA

| Surface No. | r | d | nd | νd | Effective Diameter |
|---|---|---|---|---|---|
| 1 | 47.171 | 1.87 | 1.80400 | 46.5 | 46.08 |
| 2 | 22.711 | 2.31 | | | 36.70 |
| 3* | 24.162 | 2.02 | 1.53110 | 55.9 | 35.89 |
| 4* | 12.024 | 12.89 | | | 29.05 |
| 5 | −55.245 | 1.30 | 1.49700 | 81.7 | 28.59 |
| 6 | 30.384 | 4.93 | 2.00100 | 29.1 | 26.66 |
| 7 | −575.600 | (Variable) | | | 25.86 |
| 8 | −32.636 | 0.97 | 1.60342 | 38.0 | 16.39 |
| 9 | −99.430 | (Variable) | | | 16.94 |
| 10 | −237.710 | 1.52 | 1.80400 | 46.5 | 18.31 |
| 11 | −66.734 | 4.42 | | | 18.59 |
| 12 (SP) | ∞ | 2.44 | | | 19.92 |
| 13 | 19.221 | 5.76 | 1.49700 | 81.7 | 21.41 |
| 14 | 480.236 | 3.21 | | | 20.70 |
| 15 | 27.344 | 2.83 | 1.91082 | 35.3 | 18.86 |
| 16 | 177.325 | 2.22 | | | 18.10 |
| 17 | −101.556 | 1.00 | 1.72047 | 34.7 | 16.40 |
| 18 | 13.782 | 10.26 | 1.59282 | 68.6 | 17.00 |
| 19 | −12.917 | 1.00 | 1.92286 | 20.9 | 17.08 |
| 20 | −64.308 | 1.37 | | | 19.13 |
| 21* | −55.861 | 1.92 | 1.53110 | 55.9 | 19.45 |
| 22* | −1766.888 | 4.62 | | | 22.85 |
| 23 | 163.791 | 7.11 | 1.94594 | 18.0 | 33.28 |
| 24 | −37.534 | 34.54 | | | |
| Image Plane | ∞ | | | | |

ASPHERIC DATA
3rd Surface
K = 0.00000e+00 A 4 = 3.21743e−06 A 6 = −6.08657e−08 A 8 = 2.18972e−10
A10 = −1.82457e−13
A 3 = 2.70657e−04 A 5 = −7.24404e−07 A 7 = −9.38783e−10
4th Surface
K = −1.35961e+00 A 4 = 4.88728e−05 A 6 = −2.44638e−07 A 8 = 4.21747e−10
A10 = 2.57357e−13
A 3 = 3.28781e−04 A 5 = 1.88670e−06 A 7 = −3.21714e−09
21st Surface
K = 2.02073e+01 A 4 = −2.05627e−04 A 6 = 9.51957e−07 A 8 = 1.59827e−09
A 3 = 6.16949e−04 A 5 = 2.29044e−06 A 7 = −6.20542e−08
22nd Surface
K = −3.30434e+07 A 4 = −9.21712e−05 A 6 = 1.17033e−06 A 8 = −4.97083e−10
A 3 = 4.50423e−04 A 5 = −3.81127e−06 A 7 = −3.26512e−08

VARIOUS DATA

| | |
|---|---|
| Focal Length | 15.97 |
| Fno | 1.85 |
| Half Angle of View (°) | 53.56 |
| Image Height | 21.64 |
| Overall Lens Length | 103.50 |
| BF | 14.90 |

| Object Distance/Magnification | Infinity | 0.14 Times |
|---|---|---|
| d7 | 9.65 | 4.03 |
| d9 | 3.00 | 8.62 |
| Entrance Pupil Position | 19.31 | |
| Exit Pupil Position | −100.70 | |
| Front Principal-Point Position | 33.08 | |
| Rear Principal-Point Position | −1.08 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −40.22 | 25.33 | −1.67 | −26.15 |
| 2 | 8 | −80.95 | 0.97 | −0.30 | −0.91 |
| 3 | 10 | 29.84 | 49.66 | 25.64 | −37.89 |

NUMERICAL EXAMPLE 3
UNIT: mm
SURFACE DATA

| Surface No. | r | d | nd | νd | Effective Diameter |
|---|---|---|---|---|---|
| 1 | 54.263 | 1.80 | 1.71038 | 29.4 | 40.25 |
| 2 | 18.693 | 1.72 | | | 30.92 |
| 3* | 18.123 | 1.99 | 1.53110 | 55.9 | 30.35 |
| 4* | 12.853 | 10.76 | | | 27.04 |
| 5 | −36.937 | 1.30 | 1.49700 | 81.7 | 26.58 |
| 6 | 32.558 | 5.05 | 2.01394 | 26.4 | 25.27 |
| 7 | −133.408 | (Variable) | | | 24.57 |
| 8 | −21.968 | 0.94 | 1.59500 | 44.8 | 17.96 |
| 9 | −68.163 | (Variable) | | | 18.98 |
| 10 | −145.204 | 2.39 | 1.65685 | 60.8 | 20.35 |
| 11 | −35.095 | 2.99 | | | 20.82 |
| 12 (SP) | ∞ | 1.99 | | | 21.98 |
| 13 | 18.463 | 7.07 | 1.49700 | 81.7 | 23.57 |
| 14 | −139.008 | 0.20 | | | 22.70 |
| 15 | 43.437 | 2.81 | 2.00427 | 29.4 | 21.38 |
| 16 | −838.306 | 1.19 | | | 20.56 |
| 17 | −70.276 | 1.00 | 1.68831 | 31.0 | 19.77 |
| 18 | 14.014 | 6.00 | 1.63980 | 62.6 | 17.15 |
| 19 | 1299.454 | 1.30 | | | 15.48 |
| 20 | −75.836 | 5.09 | 1.49503 | 83.2 | 15.82 |
| 21 | −12.046 | 0.90 | 1.79356 | 25.7 | 16.56 |
| 22 | −73.430 | 1.97 | | | 18.59 |
| 23* | −73.662 | 1.84 | 1.53110 | 55.9 | 19.08 |
| 24* | −10000.000 | 6.17 | | | 22.21 |
| 25 | 169.020 | 7.10 | 1.96302 | 24.1 | 35.04 |
| 26 | −41.181 | 36.16 | | | |
| Image Plane | ∞ | | | | |

ASPHERIC DATA
3rd Surface
K = 0.00000e+00 A 4 = −2.16302e−05 A 6 = 4.33290e−08 A 8 = −1.46860e−10
A10 = −1.04000e−13
4th Surface
K = −4.09435e−01 A 4 = −2.77194e−05 A 6 = 1.77503e−10 A 8 = −1.89719e−12
A10 = −1.57970e−12
23rd Surface
K = 0.00000e+00 A 4 = −2.13465e−04 A 6 = 8.40013e−07 A 8 = −3.02689e−09
24th Surface
K = 0.00000e+00 A 4 = −1.27749e−04 A 6 = 9.14292e−07 A 8 = −1.70037e−09

VARIOUS DATA

| | |
|---|---|
| Focal Length | 19.40 |
| Fno | 1.85 |
| Half Angle of View (°) | 48.12 |
| Image Height | 21.64 |
| Overall Lens Length | 98.50 |
| BF | 14.16 |

| Object Distance/Magnification | Infinity | 0.17 Times |
|---|---|---|
| d7 | 8.67 | 4.68 |
| d9 | 2.09 | 6.08 |
| Entrance Pupil Position | 18.25 | |
| Exit Pupil Position | −90.25 | |
| Front Principal-Point Position | 34.05 | |
| Rear Principal-Point Position | −5.24 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −48.71 | 22.62 | −4.12 | −26.39 |
| 2 | 8 | −54.90 | 0.94 | −0.28 | −0.88 |
| 3 | 10 | 29.29 | 50.02 | 22.37 | −44.52 |

NUMERICAL EXAMPLE 4
UNIT: mm
SURFACE DATA

| Surface No. | r | d | nd | νd | Effective Diameter |
|---|---|---|---|---|---|
| 1 | 46.684 | 3.00 | 1.80400 | 46.5 | 52.01 |
| 2 | 19.961 | 2.63 | | | 36.81 |
| 3* | 20.782 | 2.00 | 1.53110 | 55.9 | 36.23 |
| 4* | 12.821 | 14.86 | | | 31.40 |
| 5 | −43.288 | 2.50 | 1.49700 | 81.7 | 30.82 |
| 6 | 37.873 | 12.88 | 2.00100 | 29.1 | 28.56 |
| 7 | −141.631 | (Variable) | | | 24.65 |
| 8 | −25.816 | 0.95 | 1.60342 | 38.0 | 16.54 |
| 9 | −107.799 | (Variable) | | | 17.23 |
| 10 | −98.804 | 1.96 | 1.80400 | 46.5 | 18.63 |
| 11 | −34.798 | 5.68 | | | 19.00 |
| 12 (SP) | ∞ | 5.39 | | | 20.20 |
| 13 | 21.022 | 6.62 | 1.49700 | 81.7 | 21.64 |
| 14 | −6056.893 | 1.21 | | | 20.64 |
| 15 | 34.604 | 2.48 | 1.91082 | 35.3 | 19.52 |
| 16 | 156.936 | 3.28 | | | 18.84 |
| 17 | −220.642 | 1.09 | 1.72047 | 34.7 | 16.82 |
| 18 | 13.063 | 11.25 | 1.59282 | 68.6 | 17.00 |
| 19 | −13.388 | 1.00 | 1.92286 | 20.9 | 18.00 |
| 20 | −67.956 | 1.53 | | | 20.99 |
| 21* | −47.879 | 1.80 | 1.53110 | 55.9 | 21.30 |
| 22* | 520.414 | 3.82 | | | 24.87 |
| 23 | 191.839 | 7.72 | 1.94594 | 18.0 | 33.29 |
| 24 | −33.171 | 34.67 | | | |
| Image Plane | ∞ | | | | |

ASPHERIC DATA
3rd Surface
K = 0.00000e+00 A 4 = 2.07891e−05 A 6 = −5.19000e−07 A 8 = −2.06626e−10
A10 = −1.35290e−13
A 3 = 9.93172e−05 A 5 = 2.31635e−06 A 7 = 2.10795e−08
4th Surface
K = −6.68875e−01 A 4 = 4.59686e−05 A 6 = −3.16799e−07 A 8 = 4.67231e−10
A10 = −1.99855e−13
A 3 = 6.73852e−05 A 5 = 4.47768e−07 A 7 = −4.47987e−10
21st Surface
K = 1.35267e+01 A 4 = −8.36963e−05 A 6 = 1.69232e−06 A 8 = 3.61017e−09
A 3 = 1.68754e−04 A 5 = −5.57535e−06 A 7 = −1.19124e−07
22nd Surface
K = 0.00000e+00 A 4 = −5.67603e−05 A 6 = 8.23422e−07 A 8 = 3.56174e−10
A 3 = 2.00189e−04 A 5 = −8.06247e−07 A 7 = −4.06312e−08

VARIOUS DATA

| | |
|---|---|
| Focal Length | 14.81 |
| Fno | 1.85 |
| Half Angle of View (°) | 55.61 |
| Image Height | 21.64 |
| Overall Lens Length | 119.57 |
| BF | 14.96 |

| Object Distance/Magnification | Infinity | 0.15 Times |
|---|---|---|
| d7 | 7.92 | 4.10 |
| d9 | 3.04 | 6.86 |
| Entrance Pupil Position | 21.34 | |
| Exit Pupil Position | −143.80 | |
| Front Principal-Point Position | 34.77 | |
| Rear Principal-Point Position | 0.15 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −48.98 | 37.87 | −5.82 | −44.06 |
| 2 | 8 | −56.50 | 0.95 | −0.19 | −0.78 |
| 3 | 10 | 32.81 | 54.84 | 31.78 | −45.46 |

NUMERICAL EXAMPLE 5
UNIT: mm
SURFACE DATA

| Surface No. | r | d | nd | νd | Effective Diameter |
|---|---|---|---|---|---|
| 1 | 88.400 | 3.00 | 1.80400 | 46.5 | 54.15 |
| 2 | 26.895 | 3.00 | | | 41.48 |
| 3* | 23.707 | 2.00 | 1.53110 | 55.9 | 39.40 |
| 4* | 15.490 | 17.03 | | | 35.17 |
| 5 | −38.413 | 2.50 | 1.49700 | 81.7 | 32.51 |
| 6 | 53.172 | 0.72 | | | 31.10 |
| 7 | 60.005 | 10.00 | 2.00100 | 29.1 | 31.12 |
| 8 | −92.813 | (Variable) | | | 29.49 |
| 9 | −27.561 | 0.95 | 1.60342 | 38.0 | 19.66 |
| 10 | −74.649 | (Variable) | | | 20.46 |
| 11 | −205.316 | 2.29 | 1.80400 | 46.5 | 22.04 |
| 12 | −44.952 | 6.80 | | | 22.39 |
| 13 (SP) | ∞ | 10.45 | | | 23.51 |
| 14 | 25.048 | 8.52 | 1.49700 | 81.7 | 25.39 |
| 15 | 242.025 | 0.63 | | | 23.82 |
| 16 | 38.517 | 3.10 | 1.91082 | 35.3 | 23.00 |
| 17 | 178.012 | 3.16 | | | 22.16 |
| 18 | −1152.030 | 1.00 | 1.72047 | 34.7 | 21.86 |
| 19 | 13.310 | 16.78 | 1.59282 | 68.6 | 21.54 |
| 20 | −15.376 | 1.00 | 1.92286 | 20.9 | 22.66 |
| 21 | −170.190 | 2.42 | | | 25.31 |
| 22* | −55.429 | 1.97 | 1.53110 | 55.9 | 25.63 |
| 23* | 905.010 | 2.59 | | | 29.65 |
| 24 | 206.295 | 8.59 | 1.94594 | 18.0 | 35.60 |
| 25 | −33.034 | 37.00 | | | |
| Image Plane | ∞ | | | | |

ASPHERIC DATA
3rd Surface
K = 0.00000e+00 A 4 = 1.32628e−05 A 6 = −4.47249e−07 A 8 = −1.65015e−10
A10 = −8.58865e−14
A 3 = −1.25279e−04 A 5 = 2.68420e−06 A 7 = 1.74739e−08
4th Surface
K = −8.20898e−01 A 4 = 3.42198e−05 A 6 = −2.26513e−07 A 8 = 5.67319e−10
A10 = −3.78508e−13
A 3 = −1.72751e−04 A 5 = 7.38748e−07 A 7 = −2.52753e−09
22nd Surface
K = 1.26592e+01 A 4 = −6.61153e−05 A 6 = 1.67440e−06 A 8 = 3.12852e−09
A 3 = 9.52868e−05 A 5 = −6.43242e−06 A 7 = −1.13413e−07
23rd Surface
K = 0.00000e+00 A 4 = −5.23370e−05 A 6 = 7.79126e−07 A 8 = 6.72532e−10
A 3 = 1.31902e−04 A 5 = −1.07771e−06 A 7 = −4.31786e−08

VARIOUS DATA

| | |
|---|---|
| Focal Length | 16.93 |
| Fno | 1.85 |
| Half Angle of View (°) | 51.95 |
| Image Height | 21.64 |
| Overall Lens Length | 140.63 |
| BF | 17.66 |

| Object Distance/Magnification | Infinity | 0.22 Times |
|---|---|---|
| d 8 | 11.48 | 4.65 |
| d10 | 3.00 | 9.83 |
| Entrance Pupil Position | 23.18 | |
| Exit Pupil Position | −344.14 | |
| Front Principal-Point Position | 39.32 | |
| Rear Principal-Point Position | 0.73 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −52.01 | 38.24 | −6.78 | −48.71 |
| 2 | 9 | −72.96 | 0.95 | −0.35 | −0.95 |
| 3 | 11 | 42.32 | 69.30 | 45.54 | −59.56 |

NUMERICAL EXAMPLE 6
UNIT: mm
SURFACE DATA

| Surface No. | r | d | nd | νd | Effective Diameter |
|---|---|---|---|---|---|
| 1 | 42.159 | 1.80 | 1.80400 | 46.5 | 34.30 |
| 2 | 15.635 | 1.00 | | | 25.62 |
| 3* | 15.795 | 2.00 | 1.53110 | 55.9 | 24.92 |
| 4* | 10.401 | 7.84 | | | 21.35 |
| 5 | −72.201 | 1.30 | 1.49700 | 81.7 | 20.75 |
| 6 | 30.766 | 0.20 | | | 18.79 |
| 7 | 30.369 | 2.96 | 2.00100 | 29.1 | 18.69 |
| 8 | −2381.368 | (Variable) | | | 17.84 |
| 9 | −21.774 | 0.94 | 1.60342 | 38.0 | 12.13 |
| 10 | −104.815 | (Variable) | | | 12.73 |
| 11 | 174.598 | 1.84 | 1.80400 | 46.5 | 14.51 |
| 12 | −47.339 | 2.80 | | | 14.78 |
| 13 (SP) | ∞ | 1.90 | | | 15.45 |
| 14 | 17.388 | 4.31 | 1.49700 | 81.7 | 16.21 |
| 15 | −314.744 | 0.20 | | | 15.73 |
| 16 | 31.502 | 2.10 | 1.91082 | 35.3 | 15.29 |
| 17 | 200.667 | 2.65 | | | 14.74 |
| 18 | −136.250 | 1.00 | 1.72047 | 34.7 | 12.91 |
| 19 | 12.058 | 8.25 | 1.59282 | 68.6 | 12.22 |
| 20 | −14.819 | 1.00 | 1.92286 | 20.9 | 14.55 |
| 21 | −59.061 | 1.05 | | | 15.96 |
| 22* | −89.100 | 1.80 | 1.53110 | 55.9 | 16.31 |
| 23* | −174.036 | 2.67 | | | 18.92 |
| 24 | 147.125 | 3.69 | 1.94594 | 18.0 | 25.10 |
| 25 | −62.964 | 26.17 | | | |
| Image Plane | ∞ | | | | |

ASPHERIC DATA
3rd Surface
K = 0.00000e+00 A 4 = 2.99333e−05 A 6 = −3.32477e−07 A 8 = 3.13155e−10
A10 = −1.04099e−12
A 3 = 7.75721e−06 A 5 = 1.94024e−06 A 7 = −1.78117e−10
4th Surface
K = −4.78636e−01 A 4 = 9.03911e−05 A 6 = 4.94061e−07 A 8 = 4.94492e−09
A10 = −1.35561e−11
A 3 = −2.04635e−04 A 5 = −4.78336e−06 A 7 = −9.95991e−08
22nd Surface
K = 7.31323e+01 A 4 = −1.81316e−04 A 6 = −6.52451e−07 A 8 = −7.59521e−09
A 3 = 9.94772e−05 A 5 = 2.70934e−06 A 7 = 9.71306e−08
23rd Surface
K = 0.00000e+00 A 4 = −1.13344e−04 A 6 = −1.10833e−06 A 8 = −3.43599e−09
A 3 = 2.71180e−04 A 5 = 8.99932e−06 A 7 = 1.29577e−07

VARIOUS DATA

| | |
|---|---|
| Focal Length | 14.38 |
| Fno | 2.00 |
| Half Angle of View (°) | 56.39 |
| Image Height | 21.64 |
| Overall Lens Length | 75.72 |
| BF | 14.00 |

| Object Distance/Magnification | Infinity | 0.11 Times |
|---|---|---|
| d 8 | 5.45 | 3.39 |
| d10 | 2.99 | 5.05 |
| Entrance Pupil Position | 14.24 | |
| Exit Pupil Position | −33.23 | |
| Front Principal-Point Position | 24.24 | |
| Rear Principal-Point Position | −0.38 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −30.28 | 17.09 | −0.13 | −15.40 |
| 2 | 9 | −45.74 | 0.94 | −0.16 | −0.75 |
| 3 | 11 | 19.04 | 35.25 | 10.17 | −24.17 |

NUMERICAL EXAMPLE 7
UNIT: mm
SURFACE DATA

| Surface No. | r | d | nd | νd | Effective Diameter |
|---|---|---|---|---|---|
| 1 | 58.200 | 3.00 | 1.80400 | 46.5 | 48.66 |
| 2 | 22.035 | 7.09 | | | 36.10 |
| 3* | 19.082 | 2.00 | 1.53110 | 55.9 | 30.80 |
| 4* | 11.538 | 10.41 | | | 25.97 |
| 5 | −49.619 | 2.50 | 1.49700 | 81.7 | 25.44 |
| 6 | 26.802 | 0.33 | | | 23.00 |
| 7 | 28.030 | 10.00 | 2.00100 | 29.1 | 22.98 |
| 8 | −685.279 | (Variable) | | | 19.40 |
| 9 | −28.932 | 0.95 | 1.60342 | 38.0 | 16.67 |
| 10 | −84.768 | (Variable) | | | 17.29 |
| 11 | 642.558 | 1.87 | 1.80400 | 46.5 | 18.86 |
| 12 | −67.606 | 2.84 | | | 19.12 |
| 13 (SP) | ∞ | 4.29 | | | 19.77 |
| 14 | 19.125 | 5.84 | 1.49700 | 81.7 | 21.16 |
| 15 | −245.150 | 0.48 | | | 20.41 |
| 16 | 31.844 | 2.50 | 1.91082 | 35.3 | 19.28 |
| 17 | 107.732 | 2.62 | | | 18.48 |
| 18 | −94.741 | 1.00 | 1.72047 | 34.7 | 16.63 |
| 19 | 11.237 | 10.59 | 1.59282 | 68.6 | 14.78 |
| 20 | −16.726 | 1.00 | 1.92286 | 20.9 | 17.18 |
| 21 | −90.402 | 1.41 | | | 18.80 |
| 22* | −157.835 | 2.29 | 1.53110 | 55.9 | 19.15 |
| 23* | 179.479 | 4.13 | | | 22.67 |
| 24 | 233.929 | 6.10 | 1.94594 | 18.0 | 30.88 |
| 25 | −37.236 | 32.07 | | | |
| Image Plane | ∞ | | | | |

ASPHERIC DATA
3rd Surface
K = 0.00000e+00 A 4 = 1.67464e−05 A 6 = −4.07892e−07 A 8 = 1.25135e−10
A10 = −6.96454e−13
A 3 = −2.30024e−04 A 5 = 1.76413e−06 A 7 = 1.44210e−08
4th Surface
K = −5.19129e−01 A 4 = 2.58673e−05 A 6 = −8.12220e−08 A 8 = 2.75080e−09
A10 = −3.84135e−12
A 3 = −2.77971e−04 A 5 = 1.10993e−07 A 7 = −3.68275e−08
22nd Surface
K = 1.72765e+02 A 4 = −1.72314e−04 A 6 = −1.55352e−06 A 8 = −5.72938e−09
A 3 = 1.08937e−04 A 5 = 8.23248e−06 A 7 = 1.53959e−07
23rd Surface
K = 0.00000e+00 A 4 = −1.14703e−04 A 6 = −1.14958e−06 A 8 = −3.83109e−09
A 3 = 1.65854e−04 A 5 = 8.20399e−06 A 7 = 1.21240e−07

VARIOUS DATA

| | |
|---|---|
| Focal Length | 15.26 |
| Fno | 1.85 |
| Half Angle of View (°) | 54.80 |
| Image Height | 21.64 |
| Overall Lens Length | 110.14 |
| BF | 16.17 |

| Object Distance/Magnification | Infinity | 0.15 Times |
|---|---|---|
| d 8 | 7.72 | 3.11 |
| d10 | 3.00 | 7.62 |
| Entrance Pupil Position | 21.18 | |
| Exit Pupil Position | −85.75 | |
| Front Principal-Point Position | 34.16 | |
| Rear Principal-Point Position | 0.91 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −39.38 | 35.33 | −0.21 | −32.28 |
| 2 | 9 | −73.26 | 0.95 | −0.31 | −0.91 |
| 3 | 11 | 28.64 | 46.97 | 22.24 | −35.54 |

NUMERICAL EXAMPLE 8
UNIT: mm
SURFACE DATA

| Surface No. | r | d | nd | νd | Effective Diameter |
|---|---|---|---|---|---|
| 1 | 58.985 | 3.00 | 1.80400 | 46.5 | 48.86 |
| 2 | 22.105 | 6.51 | | | 36.22 |
| 3* | 19.518 | 2.00 | 1.53110 | 55.9 | 31.67 |
| 4* | 11.702 | 10.73 | | | 26.75 |
| 5 | −50.694 | 2.50 | 1.49700 | 81.7 | 26.16 |
| 6 | 26.876 | 0.38 | | | 23.74 |
| 7 | 28.546 | 10.00 | 2.00100 | 29.1 | 23.74 |
| 8 | −1356.889 | (Variable) | | | 20.29 |
| 9 | −30.208 | 0.95 | 1.59069 | 39.7 | 17.02 |
| 10 | −69.774 | (Variable) | | | 17.60 |
| 11 | 533.211 | 1.84 | 1.78921 | 47.5 | 19.12 |
| 12 | −73.851 | 2.80 | | | 19.36 |
| 13 (SP) | ∞ | 4.34 | | | 19.96 |
| 14 | 19.231 | 5.81 | 1.49700 | 81.7 | 21.28 |
| 15 | −243.365 | 0.66 | | | 20.53 |
| 16 | 32.355 | 2.40 | 1.91082 | 35.3 | 19.29 |
| 17 | 105.214 | 2.67 | | | 18.52 |
| 18 | −94.624 | 1.05 | 1.72047 | 34.7 | 16.64 |
| 19 | 11.292 | 10.61 | 1.59282 | 68.6 | 14.79 |
| 20 | −16.613 | 1.01 | 1.92286 | 20.9 | 17.19 |
| 21 | −99.294 | 1.70 | | | 18.85 |
| 22* | −176.279 | 2.24 | 1.53110 | 55.9 | 19.42 |
| 23* | 140.809 | 3.64 | | | 23.05 |
| 24 | 223.926 | 6.27 | 1.94594 | 18.0 | 30.72 |
| 25 | −35.868 | 31.96 | | | |
| Image Plane | ∞ | | | | |

ASPHERIC DATA
3rd Surface
K = 0.00000e+00 A 4 = 1.43844e−05 A 6 = −4.10784e−07 A 8 = 9.02357e−11
A10 = −6.59274e−13
A 3 = −2.17200e−04 A 5 = 1.78119e−06 A 7 = 1.46834e−08
4th Surface
K = −5.26042e−01 A 4 = 2.12966e−05 A 6 = −1.21820e−07 A 8 = 2.59322e−09
A10 = −3.86620e−12
A 3 = −2.58486e−04 A 5 = 3.78322e−07 A 7 = −3.36819e−08
22nd Surface
K = 1.26329e+02 A 4 = −1.76319e−04 A 6 = −1.57869e−06 A 8 = −5.66717e−09
A 3 = 1.09861e−04 A 5 = 8.56307e−06 A 7 = 1.54401e−07
23rd Surface
K = 0.00000e+00 A 4 = −1.15193e−04 A 6 = −1.10767e−06 A 8 = −3.76135e−09
A 3 = 1.58725e−04 A 5 = 8.00730e−06 A 7 = 1.18748e−07

VARIOUS DATA

| | |
|---|---|
| Focal Length | 15.17 |
| Fno | 1.85 |
| Half Angle of View (°) | 54.97 |
| Image Height | 21.64 |
| Overall Lens Length | 111.55 |
| BF | 16.41 |

| Object Distance/Magnification | Infinity | 0.15Times |
|---|---|---|
| d 8 | 9.04 | 3.22 |
| d10 | 3.00 | 8.82 |
| Entrance Pupil Position | 21.18 | |
| Exit Pupil Position | −87.77 | |
| Front Principal-Point Position | 34.14 | |
| Rear Principal-Point Position | 1.25 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −36.84 | 35.11 | 0.64 | −30.49 |
| 2 | 9 | −91.00 | 0.95 | −0.46 | −1.06 |
| 3 | 11 | 29.36 | 47.03 | 22.79 | −35.11 |

NUMERICAL EXAMPLE 9
UNIT: mm
SURFACE DATA

| Surface No. | r | d | nd | νd | Effective Diameter |
|---|---|---|---|---|---|
| 1 | 61.672 | 3.00 | 1.80400 | 46.5 | 48.73 |
| 2 | 21.951 | 5.87 | | | 35.96 |
| 3* | 19.773 | 2.00 | 1.53110 | 55.9 | 32.20 |
| 4* | 11.901 | 10.75 | | | 27.39 |
| 5 | −53.528 | 2.49 | 1.49700 | 81.7 | 26.91 |
| 6 | 27.475 | 0.39 | | | 24.56 |
| 7 | 29.238 | 9.96 | 2.00100 | 29.1 | 24.55 |
| 8 | −1532.768 | (Variable) | | | 21.25 |
| 9 | −31.485 | 0.95 | 1.57229 | 42.3 | 17.23 |
| 10 | −67.450 | (Variable) | | | 17.77 |
| 11 | 286.741 | 1.81 | 1.79104 | 46.9 | 19.27 |
| 12 | −89.606 | 2.86 | | | 19.48 |
| 13 (SP) | ∞ | 4.67 | | | 20.04 |
| 14 | 19.264 | 5.87 | 1.49700 | 81.7 | 21.35 |
| 15 | −220.405 | 0.64 | | | 20.58 |
| 16 | 33.154 | 2.39 | 1.91082 | 35.3 | 19.32 |
| 17 | 111.065 | 2.59 | | | 18.55 |
| 18 | −90.861 | 1.00 | 1.72047 | 34.7 | 16.73 |
| 19 | 11.295 | 10.91 | 1.59282 | 68.6 | 14.88 |
| 20 | −16.629 | 1.00 | 1.92286 | 20.9 | 17.32 |
| 21 | −113.531 | 1.77 | | | 19.01 |
| 22* | −201.522 | 2.25 | 1.53110 | 55.9 | 19.58 |
| 23* | 123.132 | 3.31 | | | 23.33 |
| 24 | 282.336 | 6.36 | 1.94594 | 18.0 | 30.41 |
| 25 | −33.703 | 31.72 | | | |
| Image Plane | ∞ | | | | |

ASPHERIC DATA
3rd Surface
K = 0.00000e+00 A 4 = 1.36342e−05 A 6 = −4.03371e−07 A 8 = 6.60751e−11
A10 = −6.20778e−13
A 3 = −2.12379e−04 A 5 = 1.74485e−06 A 7 = 1.46651e−08
4th Surface
K = −5.27201e−01 A 4 = 1.65573e−05 A 6 = −1.27547e−07 A 8 = 2.55518e−09
A10 = −3.80300e−12
A 3 = −2.40726e−04 A 5 = 5.93738e−07 A 7 = −3.32344e−08
22nd Surface
K = 7.14403e+01 A 4 = −1.83493e−04 A 6 = −1.61211e−06 A 8 = −5.55301e−09
A 3 = 1.18637e−04 A 5 = 9.07414e−06 A 7 = 1.53931e−07
23rd Surface
K = 0.00000e+00 A 4 = −1.16886e−04 A 6 = −1.09627e−06 A 8 = −3.75357e−09
A 3 = 1.56895e−04 A 5 = 7.96569e−06 A 7 = 1.18250e−07

VARIOUS DATA

| | |
|---|---|
| Focal Length | 15.10 |
| Fno | 1.85 |
| Half Angle of View (°) | 55.09 |
| Image Height | 21.64 |
| Overall Lens Length | 112.66 |
| BF | 16.66 |

| Object Distance/Magnification | Infinity | 0.15Times |
|---|---|---|
| d 8 | 10.16 | 3.31 |
| d10 | 3.00 | 9.85 |
| Entrance Pupil Position | 20.91 | |
| Exit Pupil Position | −92.04 | |
| Front Principal-Point Position | 33.91 | |
| Rear Principal-Point Position | 1.56 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −36.24 | 34.45 | 0.43 | −29.97 |
| 2 | 9 | −104.18 | 0.95 | −0.53 | −1.14 |
| 3 | 11 | 30.01 | 47.44 | 23.66 | −34.95 |

NUMERICAL EXAMPLE 10
UNIT: mm
SURFACE DATA

| Surface No. | r | d | nd | νd | Effective Diameter |
|---|---|---|---|---|---|
| 1 | 47.492 | 3.00 | 1.80400 | 46.5 | 44.26 |
| 2 | 22.595 | 1.27 | | | 34.77 |
| 3* | 20.062 | 2.00 | 1.53110 | 55.9 | 33.76 |
| 4* | 12.872 | 11.95 | | | 28.89 |
| 5 | −58.581 | 2.50 | 1.49700 | 81.7 | 27.53 |
| 6 | 28.186 | 0.20 | | | 24.53 |
| 7 | 26.633 | 4.92 | 2.00100 | 29.1 | 24.46 |
| 8 | 856.976 | (Variable) | | | 23.26 |
| 9 | −23.106 | 0.95 | 1.64966 | 45.9 | 16.64 |
| 10 | −332.239 | (Variable) | | | 17.57 |
| 11 | 308.164 | 7.64 | 1.90262 | 35.5 | 19.61 |
| 12 | −65.195 | 2.80 | | | 21.48 |
| 13 (SP) | ∞ | 2.08 | | | 22.36 |
| 14 | 20.008 | 6.87 | 1.49700 | 81.7 | 23.80 |
| 15 | −143.353 | 0.20 | | | 23.00 |
| 16 | 32.560 | 2.84 | 1.91082 | 35.3 | 21.53 |
| 17 | 108.185 | 2.29 | | | 20.57 |
| 18 | −89.774 | 1.00 | 1.72047 | 34.7 | 19.12 |
| 19 | 11.013 | 10.56 | 1.59282 | 68.6 | 16.56 |
| 20 | −17.768 | 1.00 | 1.92286 | 20.9 | 17.24 |
| 21 | −77.157 | 1.12 | | | 18.74 |
| 22* | −213.253 | 2.32 | 1.53110 | 55.9 | 19.08 |
| 23* | 140.895 | 5.54 | | | 22.05 |
| 24 | −2063.405 | 8.16 | 1.94594 | 18.0 | 29.74 |
| 25 | −36.449 | 32.36 | | | |
| Image Plane | ∞ | | | | |

ASPHERIC DATA
3rd Surface
K = 0.00000e+00 A 4 = 1.06229e−05 A 6 = −2.88298e−07 A 8 = 1.56685e−10
A10 = −5.41246e−13
A 3 = −2.19267e−04 A 5 = 1.35733e−06 A 7 = 8.95441e−09
4th Surface
K = −5.63871e−01 A 4 = 1.71401e−05 A 6 = −5.46858e−08 A 8 = 2.43602e−09
A10 = −3.00202e−12
A 3 = −2.43953e−04 A 5 = 1.01654e−06 A 7 = −3.28305e−08
22nd Surface
K = −9.62006e+01 A 4 = −1.66789e−04 A 6 = −1.82043e−06 A 8 = −5.76952e−09
A 3 = 5.68993e−05 A 5 = 1.00843e−05 A 7 = 1.65815e−07
23rd Surface
K = 0.00000e+00 A 4 = −1.08167e−04 A 6 = −1.18554e−06 A 8 = −3.92314e−09
A 3 = 7.57089e−05 A 5 = 7.57119e−06 A 7 = 1.19903e−07

VARIOUS DATA

| | |
|---|---|
| Focal Length | 19.12 |
| Fno | 1.85 |
| Half Angle of View (°) | 48.53 |
| Image Height | 21.64 |
| Overall Lens Length | 111.78 |
| BF | 19.73 |

| Object Distance/Magnification | Infinity | 0.18Times |
|---|---|---|
| d 8 | 7.87 | 4.72 |
| d10 | 3.00 | 6.15 |
| Entrance Pupil Position | 21.61 | |
| Exit Pupil Position | −81.11 | |
| Front Principal-Point Position | 37.10 | |
| Rear Principal-Point Position | 0.61 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −62.43 | 25.83 | −5.03 | −30.29 |
| 2 | 9 | −38.27 | 0.95 | −0.04 | −0.62 |
| 3 | 11 | 29.03 | 54.40 | 23.82 | −41.54 |

NUMERICAL EXAMPLE 11
UNIT: mm
SURFACE DATA

| Surface No. | r | d | nd | νd | Effective Diameter |
|---|---|---|---|---|---|
| 1 | 44.995 | 3.00 | 1.80400 | 46.5 | 45.27 |
| 2 | 23.479 | 2.33 | | | 36.20 |
| 3* | 20.142 | 2.00 | 1.53110 | 55.9 | 33.97 |
| 4* | 13.445 | 12.50 | | | 29.38 |
| 5 | −55.555 | 2.50 | 1.49700 | 81.7 | 27.55 |
| 6 | 29.366 | 0.33 | | | 24.49 |
| 7 | 26.149 | 4.79 | 2.00100 | 29.1 | 24.34 |
| 8 | 720.040 | (Variable) | | | 23.18 |
| 9 | −23.157 | 0.95 | 1.71974 | 40.9 | 17.07 |
| 10 | 576.649 | (Variable) | | | 18.07 |
| 11 | 332.960 | 7.34 | 1.95583 | 31.8 | 20.23 |
| 12 | −61.680 | 2.80 | | | 22.16 |
| 13 (SP) | ∞ | 1.94 | | | 23.15 |
| 14 | 20.499 | 7.32 | 1.49700 | 81.7 | 24.74 |
| 15 | −112.567 | 0.20 | | | 23.92 |
| 16 | 32.928 | 2.81 | 1.91082 | 35.3 | 22.22 |
| 17 | 112.590 | 2.05 | | | 21.30 |
| 18 | −82.502 | 1.00 | 1.72047 | 34.7 | 20.19 |
| 19 | 11.259 | 10.84 | 1.59282 | 68.6 | 17.38 |
| 20 | −18.050 | 1.02 | 1.92286 | 20.9 | 17.74 |
| 21 | −85.969 | 1.17 | | | 19.28 |
| 22* | −286.544 | 2.37 | 1.53110 | 55.9 | 19.62 |
| 23* | 139.178 | 5.63 | | | 22.56 |
| 24 | −1443.348 | 7.30 | 1.94594 | 18.0 | 30.08 |
| 25 | −36.947 | 32.19 | | | |
| Image Plane | ∞ | | | | |

ASPHERIC DATA
3rd Surface
K = 0.00000e+00 A 4 = 9.54008e−06 A 6 = −3.05259e−07 A 8 = 8.91085e−11
A10 = −5.09648e−13
A 3 = −1.67828e−04 A 5 = 1.65643e−06 A 7 = 1.01331e−08
4th Surface
K = −5.99532e−01 A 4 = 1.69383e−05 A 6 = −6.86604e−08 A 8 = 2.30816e−09
A10 = −2.98039e−12
A 3 = −1.73229e−04 A 5 = 1.60704e−06 A 7 = −3.06031e−08
22nd Surface
K = −5.00447e+00 A 4 = −1.59931e−04 A 6 = −1.83007e−06 A 8 = −5.70648e−09
A 3 = 4.61818e−05 A 5 = 1.02649e−05 A 7 = 1.66893e−07
23rd Surface
K = 0.00000e+00 A 4 = −1.07010e−04 A 6 = −1.21177e−06 A 8 = −3.89460e−09
A 3 = 5.15450e−05 A 5 = 7.61463e−06 A 7 = 1.19823e−07

VARIOUS DATA

| | |
|---|---|
| Focal Length | 20.48 |
| Fno | 1.85 |
| Half Angle of View (°) | 46.56 |
| Image Height | 21.64 |
| Overall Lens Length | 114.78 |
| BF | 22.15 |

| Object Distance/Magnification | Infinity | 0.20Times |
|---|---|---|
| d 8 | 7.45 | 4.70 |
| d10 | 3.00 | 5.75 |
| Entrance Pupil Position | 23.48 | |
| Exit Pupil Position | −76.02 | |
| Front Principal-Point Position | 39.69 | |
| Rear Principal-Point Position | 1.67 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −89.79 | 27.44 | −10.89 | −40.48 |
| 2 | 9 | −30.91 | 0.95 | 0.02 | −0.53 |
| 3 | 11 | 28.37 | 53.79 | 22.38 | −41.52 |

NUMERICAL EXAMPLE 12
UNIT: mm
SURFACE DATA

| Surface No. | r | d | nd | νd | Effective Diameter |
|---|---|---|---|---|---|
| 1 | 31.684 | 1.80 | 1.80400 | 46.5 | 43.38 |
| 2 | 22.709 | 3.35 | | | 37.20 |
| 3* | 21.068 | 2.85 | 1.53110 | 55.9 | 36.32 |
| 4* | 14.860 | 6.87 | | | 30.32 |
| 5 | 118.519 | 1.30 | 1.49700 | 81.7 | 29.64 |
| 6 | 18.636 | 0.42 | | | 24.66 |
| 7 | 19.343 | 10.00 | 1.73700 | 28.0 | 24.55 |
| 8 | −176.097 | 0.48 | | | 18.97 |
| 9 | −84.073 | 1.54 | 2.00127 | 29.1 | 18.15 |
| 10 | 20.549 | (Variable) | | | 15.46 |
| 11 | −19.351 | 2.49 | 2.00104 | 29.1 | 15.46 |
| 12 | −28.823 | (Variable) | | | 17.66 |
| 13 | 117.449 | 3.04 | 1.92286 | 20.9 | 22.49 |
| 14 | −53.903 | 2.80 | | | 22.96 |
| 15 (SP) | ∞ | 2.47 | | | 24.17 |
| 16 | 22.148 | 8.71 | 1.49700 | 81.7 | 26.21 |
| 17 | −91.591 | 0.87 | | | 25.19 |
| 18 | 34.952 | 2.77 | 1.91082 | 35.3 | 23.00 |
| 19 | 116.563 | 1.51 | | | 22.13 |
| 20 | −125.869 | 1.00 | 1.72047 | 34.7 | 21.53 |
| 21 | 12.119 | 10.30 | 1.59282 | 68.6 | 18.57 |
| 22 | −16.045 | 1.00 | 1.92286 | 20.9 | 17.23 |
| 23 | −60.384 | 4.07 | | | 18.03 |
| 24* | −698.577 | 1.80 | 1.53110 | 55.9 | 20.26 |
| 25* | 308.374 | 8.20 | | | 22.00 |
| 26 | 307.006 | 4.37 | 1.94594 | 18.0 | 30.15 |
| 27 | −54.651 | 30.82 | | | |
| Image Plane | ∞ | | | | |

ASPHERIC DATA
3rd Surface
K = 0.00000e+00 A 4 = −3.51883e−05 A 6 = −3.67603e−07 A 8 = −1.87348e−10
A10 = −2.58894e−13
A 3 = −2.59992e−04 A 5 = 3.39735e−06 A 7 = 1.77451e−08
4th Surface
K = −3.00432e−01 A 4 = −7.70077e−06 A 6 = 2.44429e−08 A 8 = 2.36989e−09
A10 = −2.82828e−12
A 3 = −5.11273e−04 A 5 = −1.23531e−07 A 7 = −3.06036e−08
24th Surface
K = −5.50254e+04 A 4 = −1.11270e−04 A 6 = −2.75785e−07 A 8 = −2.76248e−09
A 3 = 3.40562e−05 A 5 = −3.88171e−08 A 7 = 5.51799e−08
25th Surface
K = 0.00000e+00 A 4 = −1.01994e−04 A 6 = −7.15544e−07 A 8 = −2.56233e−09
A 3 = 1.99517e−04 A 5 = 4.83185e−06 A 7 = 7.72270e−08

VARIOUS DATA

| | |
|---|---|
| Focal Length | 18.31 |
| Fno | 1.85 |
| Half Angle of View (°) | 49.76 |
| Image Height | 21.64 |
| Overall Lens Length | 115.97 |
| BF | 21.04 |

| Object Distance/Magnification | Infinity | 0.18Times |
|---|---|---|
| d10 | 7.93 | 4.61 |
| d12 | 2.99 | 6.31 |
| Entrance Pupil Position | 25.45 | |
| Exit Pupil Position | −91.01 | |
| Front Principal-Point Position | 40.76 | |
| Rear Principal-Point Position | 2.73 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −15.39 | 28.60 | 17.28 | −2.19 |
| 2 | 11 | −67.74 | 2.49 | −2.93 | −4.37 |
| 3 | 13 | 27.85 | 52.91 | 21.11 | −50.99 |

NUMERICAL EXAMPLE 13
UNIT: mm
SURFACE DATA

| Surface No. | r | d | nd | νd | Effective Diameter |
|---|---|---|---|---|---|
| 1 | 32.906 | 3.00 | 1.88595 | 38.1 | 36.64 |
| 2 | 17.053 | 3.32 | | | 27.94 |
| 3* | 24.770 | 2.65 | 1.53110 | 55.9 | 27.15 |
| 4* | 17.717 | 5.91 | | | 23.49 |
| 5 | −82.887 | 1.30 | 1.49700 | 81.7 | 22.86 |
| 6 | 24.069 | 0.20 | | | 20.31 |
| 7 | 24.092 | 5.15 | 1.92180 | 24.0 | 20.23 |
| 8 | 30.297 | (Variable) | | | 17.46 |
| 9 | −24.588 | 2.59 | 1.85165 | 40.8 | 17.70 |
| 10 | −33.899 | (Variable) | | | 19.58 |
| 11 | 73.817 | 2.88 | 1.84607 | 24.6 | 23.52 |
| 12 | −101.430 | 2.80 | | | 23.79 |
| 13 (SP) | ∞ | 4.80 | | | 24.49 |
| 14 | 21.327 | 7.64 | 1.49700 | 81.7 | 26.38 |
| 15 | −169.796 | 1.56 | | | 25.40 |
| 16 | 33.567 | 2.76 | 1.72676 | 28.6 | 22.75 |
| 17 | 105.689 | 1.34 | | | 21.83 |
| 18 | −213.570 | 1.00 | 1.72047 | 34.7 | 21.26 |
| 19 | 11.518 | 11.98 | 1.59282 | 68.6 | 18.21 |
| 20 | −14.546 | 1.00 | 1.92286 | 20.9 | 16.98 |
| 21 | −215.737 | 1.07 | | | 18.77 |
| 22* | −279.101 | 1.80 | 1.53110 | 55.9 | 19.15 |
| 23* | −329.583 | 4.08 | | | 20.88 |
| 24 | −710.181 | 4.49 | 1.94594 | 18.0 | 26.13 |
| 25 | −34.246 | 27.13 | | | |
| Image Plane | ∞ | | | | |

ASPHERIC DATA
3rd Surface
K = 0.00000e+00 A 4 = 7.48183e−06 A 6 = −4.21874e−07 A 8 = −3.46329e−10
A10 = −3.43284e−13
A 3 = −6.64607e−05 A 5 = 3.05823e−06 A 7 = 2.54093e−08
4th Surface
K = −7.80427e−01 A 4 = 4.24803e−05 A 6 = −7.86338e−08 A 8 = 2.42425e−09
A10 = −4.49468e−12
A 3 = −1.77123e−04 A 5 = 4.94981e−07 A 7 = −1.61106e−08
22nd Surface
K = −1.65667e+02 A 4 = −1.47486e−04 A 6 = −1.68216e−06 A 8 = −6.06118e−09
A 3 = 1.87935e−04 A 5 = 1.00354e−05 A 7 = 1.72071e−07
23rd Surface
K = 0.00000e+00 A 4 = −1.08788e−04 A 6 = −1.27228e−06 A 8 = −4.28618e−09
A 3 = 2.26996e−04 A 5 = 8.92501e−06 A 7 = 1.27848e−07

VARIOUS DATA

| | |
|---|---|
| Focal Length | 17.46 |
| Fno | 1.85 |
| Half Angle of View (°) | 51.09 |
| Image Height | 21.64 |
| Overall Lens Length | 113.62 |
| BF | 26.25 |

| Object Distance/Magnification | Infinity | 0.18Times |
|---|---|---|
| d 8 | 11.06 | 4.47 |
| d10 | 3.00 | 9.59 |
| Entrance Pupil Position | 19.70 | |
| Exit Pupil Position | −73.42 | |
| Front Principal-Point Position | 34.11 | |
| Rear Principal-Point Position | 8.78 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −17.76 | 21.53 | 9.40 | −5.54 |
| 2 | 9 | −120.51 | 2.59 | −4.23 | −5.83 |
| 3 | 11 | 29.43 | 49.20 | 20.45 | −39.36 |

NUMERICAL EXAMPLE 14
UNIT: mm
SURFACE DATA

| Surface No. | r | d | nd | νd | Effective Diameter |
|---|---|---|---|---|---|
| 1 | 63.995 | 2.05 | 1.80400 | 46.5 | 49.25 |
| 2 | 22.950 | 8.18 | | | 37.60 |
| 3* | 19.505 | 2.00 | 1.53110 | 55.9 | 32.04 |
| 4* | 11.845 | 11.90 | | | 27.44 |
| 5 | −59.796 | 2.50 | 1.49700 | 81.7 | 25.78 |
| 6 | 27.084 | 0.32 | | | 23.50 |
| 7 | 28.246 | 7.50 | 2.00100 | 29.1 | 23.48 |
| 8 | −195.976 | (Variable) | | | 21.28 |
| 9 | −28.714 | 0.95 | 1.69821 | 29.7 | 16.63 |
| 10 | −113.862 | (Variable) | | | 17.22 |
| 11 | 484.877 | 3.67 | 1.82106 | 38.1 | 19.12 |
| 12 | −69.917 | 2.80 | | | 19.74 |
| 13 (SP) | ∞ | 4.58 | | | 20.31 |
| 14 | 19.324 | 5.96 | 1.49700 | 81.7 | 21.59 |
| 15 | −220.037 | 0.54 | | | 20.79 |
| 16 | 32.344 | 2.44 | 1.91082 | 35.3 | 19.52 |
| 17 | 106.239 | 2.65 | | | 18.72 |
| 18 | −94.598 | 1.00 | 1.72047 | 34.7 | 16.81 |
| 19 | 11.083 | 10.59 | 1.59282 | 68.6 | 14.85 |
| 20 | −16.880 | 1.00 | 1.92286 | 20.9 | 17.14 |
| 21 | −77.873 | 1.75 | | | 18.68 |
| 22* | −159.413 | 2.13 | 1.53110 | 55.9 | 19.31 |
| 23* | 103.675 | 4.99 | | | 22.83 |
| 24 | 376.377 | 6.39 | 1.94594 | 18.0 | 31.72 |
| 25 | −35.425 | 32.97 | | | |
| Image Plane | ∞ | | | | |

ASPHERIC DATA
3rd Surface
K = 0.00000e+00 A 4 = 1.47465e−05 A 6 = −4.09601e−07 A 8 = 9.47305e−11
A10 = −6.39666e−13
A 3 = −2.30753e−04 A 5 = 1.74126e−06 A 7 = 1.45848e−08
4th Surface
K = −5.22244e−01 A 4 = 1.80497e−05 A 6 = −1.22610e−07 A 8 = 2.59466e−09
A10 = −3.87126e−12
A 3 = −2.64519e−04 A 5 = 2.58594e−07 A 7 = −3.37604e−08
22nd Surface
K = 1.30148e+02 A 4 = −1.77686e−04 A 6 = −1.58990e−06 A 8 = −5.72904e−09
A 3 = 1.02393e−04 A 5 = 8.53693e−06 A 7 = 1.53883e−07
23rd Surface
K = 0.00000e+00 A 4 = −1.15845e−04 A 6 = −1.11441e−06 A 8 = −3.80765e−09
A 3 = 1.47371e−04 A 5 = 7.95161e−06 A 7 = 1.18414e−07

VARIOUS DATA

| | |
|---|---|
| Focal Length | 15.41 |
| Fno | 1.85 |
| Half Angle of View (°) | 54.53 |
| Image Height | 21.64 |
| Overall Lens Length | 112.16 |
| BF | 14.94 |

| Object Distance/Magnification | Infinity | 0.15Times |
|---|---|---|
| d 8 | 7.40 | 3.25 |
| d10 | 3.93 | 8.08 |
| Entrance Pupil Position | 21.24 | |
| Exit Pupil Position | −102.13 | |
| Front Principal-Point Position | 34.63 | |
| Rear Principal-Point Position | −0.47 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −65.24 | 34.45 | −12.95 | −56.46 |
| 2 | 9 | −55.25 | 0.95 | −0.19 | −0.75 |
| 3 | 11 | 30.29 | 50.49 | 25.40 | −39.20 |

NUMERICAL EXAMPLE 15
UNIT: mm
SURFACE DATA

| Surface No. | r | d | nd | νd | Effective Diameter |
|---|---|---|---|---|---|
| 1 | 72.693 | 1.86 | 1.80400 | 46.5 | 51.24 |
| 2 | 24.217 | 10.56 | | | 39.29 |
| 3* | 19.609 | 2.01 | 1.53110 | 55.9 | 31.99 |
| 4* | 12.105 | 14.88 | | | 27.63 |
| 5 | −62.649 | 2.50 | 1.49700 | 81.7 | 23.10 |
| 6 | 26.905 | 0.29 | | | 21.01 |
| 7 | 27.970 | 9.96 | 2.00100 | 29.1 | 20.98 |
| 8 | −128.574 | (Variable) | | | 17.44 |
| 9 | −28.796 | 0.95 | 1.78963 | 27.5 | 17.46 |
| 10 | −462.438 | (Variable) | | | 18.11 |
| 11 | 353.074 | 2.08 | 1.89263 | 32.7 | 19.75 |
| 12 | −63.391 | 2.80 | | | 20.02 |
| 13 (SP) | ∞ | 5.76 | | | 20.59 |
| 14 | 19.348 | 6.19 | 1.49700 | 81.7 | 22.06 |
| 15 | −178.411 | 0.20 | | | 21.23 |
| 16 | 32.541 | 2.49 | 1.91082 | 35.3 | 20.00 |
| 17 | 107.506 | 2.45 | | | 19.17 |
| 18 | −91.892 | 1.00 | 1.72047 | 34.7 | 17.42 |
| 19 | 10.904 | 10.98 | 1.59282 | 68.6 | 15.24 |
| 20 | −17.168 | 1.00 | 1.92286 | 20.9 | 17.45 |
| 21 | −67.652 | 1.88 | | | 18.88 |
| 22* | −186.893 | 2.36 | 1.53110 | 55.9 | 19.57 |
| 23* | 84.125 | 5.87 | | | 23.22 |
| 24 | 1732.934 | 6.28 | 1.94594 | 18.0 | 32.25 |
| 25 | −35.022 | 33.49 | | | |
| Image Plane | ∞ | | | | |

ASPHERIC DATA
3rd Surface
K = 0.00000e+00 A 4 = 1.48996e−05 A 6 = −3.98821e−07 A 8 = 1.05859e−10
A10 = −6.60157e−13
A 3 = −2.56711e−04 A 5 = 1.61043e−06 A 7 = 1.40911e−08
4th Surface
K = −5.13331e−01 A 4 = 1.58904e−05 A 6 = −1.20252e−07 A 8 = 2.60366e−09
A10 = −3.79474e−12
A 3 = −2.88252e−04 A 5 = 2.69752e−07 A 7 = −3.42404e−08
22nd Surface
K = 7.70036e+01 A 4 = −1.82183e−04 A 6 = −1.61373e−06 A 8 = −5.60261e−09
A 3 = 9.27069e−05 A 5 = 8.69396e−06 A 7 = 1.53909e−07
23rd Surface
K = 0.00000e+00 A 4 = −1.16419e−04 A 6 = −1.11816e−06 A 8 = −3.85116e−09
A 3 = 1.32571e−04 A 5 = 7.89814e−06 A 7 = 1.18734e−07

VARIOUS DATA

| | |
|---|---|
| Focal Length | 15.26 |
| Fno | 1.85 |
| Half Angle of View (°) | 54.80 |
| Image Height | 21.64 |
| Overall Lens Length | 116.92 |
| BF | 14.15 |

| Object Distance/Magnification | Infinity | 0.15Times |
|---|---|---|
| d 8 | 5.42 | 2.56 |
| d10 | 3.00 | 5.87 |
| Entrance Pupil Position | 22.00 | |
| Exit Pupil Position | −122.68 | |
| Front Principal-Point Position | 35.56 | |
| Rear Principal-Point Position | −1.11 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −168.18 | 42.06 | −66.89 | −176.78 |
| 2 | 9 | −38.93 | 0.95 | −0.04 | −0.57 |
| 3 | 11 | 30.80 | 51.33 | 26.15 | −44.61 |

NUMERICAL EXAMPLE 16
UNIT: mm
SURFACE DATA

| Surface No. | r | d | nd | νd | Effective Diameter |
|---|---|---|---|---|---|
| 1 | 74.630 | 1.92 | 1.80400 | 46.5 | 52.56 |
| 2 | 24.543 | 11.72 | | | 40.14 |
| 3* | 19.634 | 2.00 | 1.53110 | 55.9 | 32.23 |
| 4* | 12.164 | 15.65 | | | 27.95 |
| 5 | −67.970 | 2.50 | 1.49700 | 81.7 | 22.91 |
| 6 | 27.011 | 0.27 | | | 20.87 |
| 7 | 27.870 | 9.50 | 2.00100 | 29.1 | 20.84 |
| 8 | −123.341 | (Variable) | | | 17.58 |
| 9 | −28.726 | 0.95 | 1.80156 | 26.9 | 17.60 |
| 10 | −730.560 | (Variable) | | | 18.25 |
| 11 | 344.990 | 2.12 | 1.89063 | 32.0 | 19.87 |
| 12 | −63.194 | 2.80 | | | 20.14 |
| 13 (SP) | ∞ | 5.81 | | | 20.69 |
| 14 | 19.349 | 6.22 | 1.49700 | 81.7 | 22.11 |
| 15 | −172.603 | 0.20 | | | 21.27 |
| 16 | 32.699 | 2.48 | 1.91082 | 35.3 | 20.01 |
| 17 | 107.893 | 2.41 | | | 19.18 |
| 18 | −92.384 | 1.00 | 1.72047 | 34.7 | 17.45 |
| 19 | 10.875 | 10.94 | 1.59282 | 68.6 | 15.25 |
| 20 | −17.209 | 1.00 | 1.92286 | 20.9 | 17.37 |
| 21 | −70.324 | 1.91 | | | 18.80 |
| 22* | −184.036 | 2.33 | 1.53110 | 55.9 | 19.51 |
| 23* | 83.025 | 5.85 | | | 23.13 |
| 24 | 1929.722 | 6.27 | 1.94594 | 18.0 | 32.14 |
| 25 | −34.895 | 33.38 | | | |
| Image Plane | ∞ | | | | |

ASPHERIC DATA
3rd Surface
K = 0.00000e+00 A 4 = 1.46284e−05 A 6 = −3.98528e−07 A 8 = 1.05251e−10
A10 = −6.69790e−13
A 3 = −2.62183e−04 A 5 = 1.59814e−06 A 7 = 1.41107e−08
4th Surface
K = −5.11509e−01 A 4 = 1.47710e−05 A 6 = −1.20712e−07 A 8 = 2.59890e−09
A10 = −3.79119e−12
A 3 = −2.94375e−04 A 5 = 2.79259e−07 A 7 = −3.42577e−08
22nd Surface
K = 6.60852e+01 A 4 = −1.83574e−04 A 6 = −1.61713e−06 A 8 = −5.53054e−09
A 3 = 9.56867e−05 A 5 = 8.84689e−06 A 7 = 1.52888e−07
23rd Surface
K = 0.00000e+00 A 4 = −1.16357e−04 A 6 = −1.11713e−06 A 8 = −3.86319e−09
A 3 = 1.31844e−04 A 5 = 7.90789e−06 A 7 = 1.18787e−07

VARIOUS DATA

| | |
|---|---|
| Focal Length | 15.21 |
| Fno | 1.85 |
| Half Angle of View (°) | 54.89 |
| Image Height | 21.64 |
| Overall Lens Length | 118.38 |
| BF | 14.12 |

| Object Distance/Magnification | Infinity | 0.15Times |
|---|---|---|
| d 8 | 5.43 | 2.57 |
| d10 | 3.00 | 5.86 |
| Entrance Pupil Position | 22.59 | |
| Exit Pupil Position | −120.42 | |
| Front Principal-Point Position | 36.08 | |
| Rear Principal-Point Position | −1.09 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −337.09 | 43.55 | −155.70 | −366.70 |
| 2 | 9 | −37.33 | 0.95 | −0.02 | −0.55 |
| 3 | 11 | 30.84 | 51.33 | 26.00 | −44.55 |

NUMERICAL EXAMPLE 17
UNIT: mm
SURFACE DATA

| Surface No. | r | d | nd | νd | Effective Diameter |
|---|---|---|---|---|---|
| 1 | 49.562 | 1.82 | 1.80400 | 46.5 | 47.19 |
| 2 | 22.849 | 5.46 | | | 37.43 |
| 3* | 21.687 | 2.00 | 1.58313 | 59.4 | 34.52 |
| 4* | 12.749 | 12.09 | | | 29.35 |
| 5 | −57.580 | 2.50 | 1.43875 | 94.7 | 28.06 |
| 6 | 27.466 | 0.47 | | | 25.40 |
| 7 | 28.450 | 10.00 | 2.00100 | 29.1 | 25.37 |
| 8 | 778.383 | (Variable) | | | 21.67 |
| 9 | −26.853 | 0.95 | 1.62590 | 55.2 | 17.17 |
| 10 | −102.433 | (Variable) | | | 17.88 |
| 11 | 278.646 | 3.89 | 1.82252 | 43.3 | 19.58 |
| 12 | −96.831 | 2.80 | | | 20.29 |
| 13 (SP) | ∞ | (Variable) | | | 21.08 |
| 14 | 20.536 | 6.34 | 1.49700 | 81.7 | 22.86 |
| 15 | −136.243 | 0.33 | | | 22.17 |
| 16 | 32.456 | 2.61 | 1.91082 | 35.3 | 20.86 |
| 17 | 108.593 | 2.24 | | | 20.06 |
| 18 | −101.010 | 1.00 | 1.72047 | 34.7 | 18.67 |
| 19 | 11.475 | 11.32 | 1.59282 | 68.6 | 16.42 |
| 20 | −18.177 | 1.00 | 1.92286 | 20.9 | 18.38 |
| 21 | −113.148 | 1.15 | | | 19.92 |
| 22* | 801.314 | 2.32 | 1.53110 | 55.9 | 20.24 |
| 23* | 91.304 | (Variable) | | | 23.32 |
| 24 | 2295.372 | 6.12 | 1.94594 | 18.0 | 31.41 |
| 25 | −34.271 | 32.58 | | | |
| Image Plane | ∞ | | | | |

ASPHERIC DATA
3rd Surface
K = 0.00000e+00 A 4 = 2.08748e−05 A 6 = −3.42276e−08 A 8 = 1.50287e−10
A10 = −2.84548e−13
A 3 = −2.41567e−04 A 5 = −1.40410e−06 A 7 = 5.28246e−10
4th Surface
K = −6.12681e−01 A 4 = 2.72151e−05 A 6 = 5.16164e−08 A 8 = 9.72809e−10
A10 = −1.18951e−12
A 3 = −2.76213e−04 A 5 = −1.94043e−06 A 7 = −1.56769e−08
22nd Surface
K = 4.28682e+03 A 4 = −1.44165e−04 A 6 = −1.32874e−06 A 8 = −4.07539e−09
A 3 = 7.05410e−05 A 5 = 6.89407e−06 A 7 = 1.18829e−07
23rd Surface
K = 0.00000e+00 A 4 = −8.95319e−05 A 6 = −8.82445e−07 A 8 = −2.62287e−09
A 3 = 1.17923e−04 A 5 = 5.51519e−06 A 7 = 8.76857e−08

VARIOUS DATA

| | |
|---|---|
| Focal Length | 16.53 |
| Fno | 1.85 |
| Half Angle of View (°) | 52.63 |
| Image Height | 21.64 |
| Overall Lens Length | 118.10 |
| BF | 19.70 |

| Object Distance/Magnification | Infinity | 0.17Times |
|---|---|---|
| d 8 | 9.15 | 4.72 |
| d10 | 3.00 | 7.43 |
| d13 | 4.11 | 3.67 |
| d23 | 5.72 | 6.17 |
| Entrance Pupil Position | 21.83 | |
| Exit Pupil Position | −102.69 | |
| Front Principal-Point Position | 36.12 | |
| Rear Principal-Point Position | 3.17 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −50.57 | 34.34 | −4.33 | −37.53 |
| 2 | 9 | −58.43 | 0.95 | −0.21 | −0.80 |
| 3 | 11 | 87.78 | 6.69 | 1.59 | −3.35 |
| 4 | 14 | 38.17 | 28.32 | −11.73 | −24.04 |
| 5 | 24 | 35.74 | 6.12 | 3.10 | −0.05 |

NUMERICAL EXAMPLE 18
UNIT: mm
SURFACE DATA

| Surface No. | r | d | nd | νd | Effective Diameter |
|---|---|---|---|---|---|
| 1 | 63.477 | 3.00 | 1.70929 | 55.9 | 53.30 |
| 2 | 22.042 | (Variable) | | | 38.18 |
| 3* | 22.881 | 2.00 | 1.58313 | 59.4 | 36.64 |
| 4* | 13.963 | (Variable) | | | 31.88 |
| 5 | −44.232 | 2.50 | 1.43875 | 94.7 | 29.30 |
| 6 | 28.484 | 0.83 | | | 26.22 |
| 7 | 31.162 | 10.00 | 2.00100 | 29.1 | 26.17 |
| 8 | −552.191 | (Variable) | | | 22.66 |
| 9 | −29.356 | 2.95 | 1.64612 | 33.0 | 21.13 |
| 10 | −186.815 | (Variable) | | | 22.98 |
| 11 | 91.478 | 4.14 | 1.81335 | 47.8 | 25.52 |
| 12 | −88.332 | 2.80 | | | 25.94 |
| 13 (SP) | ∞ | 6.32 | | | 26.30 |
| 14* | 21.664 | 7.73 | 1.49700 | 81.7 | 27.36 |
| 15* | −213.273 | 0.20 | | | 26.20 |
| 16 | 30.234 | 2.66 | 1.91082 | 35.3 | 23.93 |
| 17 | 60.984 | 2.13 | | | 22.89 |
| 18 | −120.198 | 1.00 | 1.72047 | 34.7 | 22.21 |
| 19 | 12.568 | 14.16 | 1.59282 | 68.6 | 18.95 |
| 20 | −17.395 | 1.00 | 1.92286 | 20.9 | 20.91 |
| 21 | −118.697 | 1.89 | | | 23.02 |
| 22* | 84.122 | 2.38 | 1.53110 | 55.9 | 23.60 |
| 23* | 57.483 | 2.62 | | | 27.77 |
| 24 | 618.342 | 7.64 | 1.94594 | 18.0 | 33.12 |
| 25 | −30.590 | 34.56 | | | |
| Image Plane | ∞ | | | | |

ASPHERIC DATA
3rd Surface
K = 0.00000e+00 A 4 = 2.48205e−05 A 6 = 2.36798e−07 A 8 = 5.14747e−10
A10 = −3.94700e−13
A 3 = −1.75521e−04 A 5 = −3.61806e−06 A 7 = −1.40081e−08
4th Surface
K = −7.97401e−01 A 4 = 5.30744e−05 A 6 = 4.65123e−07 A 8 = 1.72823e−09
A10 = −1.64022e−12
A 3 = −2.88569e−04 A 5 = −5.96635e−06 A 7 = −3.81462e−08
14th Surface
K = 0.00000e+00 A 4 = 1.16379e−07 A 6 = 7.51008e−10 A 8 = 3.70427e−11
15th Surface
K = 0.00000e+00 A 4 = 2.89557e−06 A 6 = 5.43076e−09 A 8 = −1.54892e−11
22nd Surface
K = 3.45493e+01 A 4 = −1.30089e−04 A 6 = −8.50172e−07 A 8 = −2.98229e−09
A 3 = −7.14251e−05 A 5 = 1.67963e−07 A 7 = 9.88303e−08
23rd Surface
K = 0.00000e+00 A 4 = −9.72026e−05 A 6 = −8.55559e−07 A 8 = −3.23623e−09
A 3 = 9.14608e−05 A 5 = 2.72393e−06 A 7 = 1.07493e−07

VARIOUS DATA

| | |
|---|---|
| Focal Length | 14.59 |
| Fno | 1.40 |
| Half Angle of View (°) | 56.00 |
| Image Height | 21.64 |
| Overall Lens Length | 121.56 |
| BF | 14.50 |

| Object Distance/Magnification | Infinity | 0.16Times |
|---|---|---|
| d 2 | 4.84 | 3.79 |
| d 4 | 14.11 | 15.16 |
| d 8 | 7.16 | 3.66 |
| d10 | 3.00 | 6.50 |
| Entrance Pupil Position | 21.97 | |
| Exit Pupil Position | −255.28 | |
| Front Principal-Point Position | 35.77 | |
| Rear Principal-Point Position | −0.09 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −49.08 | 3.00 | 2.77 | 0.96 |
| 2 | 3 | −66.96 | 2.00 | 3.53 | 2.15 |
| 3 | 5 | 104.36 | 13.33 | 7.27 | −0.04 |
| 4 | 9 | −54.30 | 2.95 | −0.34 | −2.14 |
| 5 | 11 | 34.04 | 56.67 | 34.65 | −47.65 |

NUMERICAL EXAMPLE 19
UNIT: mm
SURFACE DATA

| Surface No. | r | d | nd | νd | Effective Diameter |
|---|---|---|---|---|---|
| 1 | 54.261 | 2.68 | 1.82048 | 43.1 | 47.71 |
| 2 | 22.213 | 4.57 | | | 36.39 |
| 3* | 22.246 | 2.00 | 1.53514 | 48.1 | 34.91 |
| 4* | 12.827 | 14.95 | | | 29.93 |
| 5 | −68.928 | 2.50 | 1.51279 | 61.9 | 26.00 |
| 6 | 27.259 | 0.27 | | | 23.86 |
| 7 | 27.893 | 9.96 | 2.00100 | 29.1 | 23.86 |
| 8 | −272.856 | (Variable) | | | 20.54 |
| 9 | −30.726 | 1.67 | 1.61925 | 47.8 | 17.40 |
| 10 | −308.121 | (Variable) | | | 18.22 |
| 11 | 292.789 | 2.94 | 1.90103 | 31.8 | 19.68 |
| 12 | −97.585 | 3.35 | | | 20.12 |
| 13 (SP) | ∞ | 4.32 | | | 20.84 |
| 14 | 19.691 | 6.50 | 1.49700 | 81.7 | 22.28 |
| 15 | −110.967 | 0.38 | | | 21.46 |
| 16 | 31.664 | 2.35 | 1.91082 | 35.3 | 19.95 |
| 17 | 80.008 | 1.58 | | | 19.11 |
| 18 | −109.727 | 1.40 | 1.72047 | 34.7 | 18.47 |
| 19 | 11.164 | 11.21 | 1.59282 | 68.6 | 16.02 |
| 20 | −18.137 | 1.00 | 1.92286 | 20.9 | 18.02 |
| 21 | −174.540 | 1.31 | | | 19.57 |
| 22* | 294.582 | 1.83 | 1.53110 | 55.9 | 19.91 |
| 23* | 98.133 | 5.65 | | | 22.51 |
| 24 | −1057.283 | 5.88 | 1.94594 | 18.0 | 30.62 |
| 25 | −33.034 | 31.82 | | | |
| Image Plane | ∞ | | | | |

ASPHERIC DATA
3rd Surface
K = 0.00000e+00 A 4 = 2.08400e−05 A 6 = 2.18344e−07 A 8 = 4.39293e−10
A10 = −3.24547e−13
A 3 = −2.86100e−04 A 5 = −3.12404e−06 A 7 = −1.34043e−08
4th Surface
K = −6.57296e−01 A 4 = 3.59457e−05 A 6 = −4.93771e−07 A 8 = 1.42747e−09
A10 = −1.17658e−12
A 3 = −3.55444e−04 A 5 = −5.47237e−06 A 7 = −3.89629e−08
22nd Surface
K = 6.76629e+02 A 4 = −1.51958e−04 A 6 = −9.99970e−07 A 8 = −3.67698e−09
A 3 = 4.21031e−05 A 5 = 4.03115e−06 A 7 = 9.89842e−08
23rd Surface
K = 0.00000e+00 A 4 = −9.93429e−05 A 6 = −9.85332e−07 A 8 = −3.11827e−09
A 3 = 1.01109e−04 A 5 = 5.11501e−06 A 7 = 1.05269e−07

VARIOUS DATA

| | |
|---|---|
| Focal Length | 16.10 |
| Fno | 1.85 |
| Half Angle of View (°) | 53.34 |
| Image Height | 21.64 |
| Overall Lens Length | 117.46 |
| BF | 18.64 |

| Object Distance/Magnification | Infinity | 0.16Times |
|---|---|---|
| d 8 | 7.51 | 3.07 |
| d10 | 3.00 | 7.43 |
| Entrance Pupil Position | 21.47 | |
| Exit Pupil Position | −94.09 | |
| Front Principal-Point Position | 35.27 | |
| Rear Principal-Point Position | 2.54 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −68.85 | 36.93 | −14.58 | −60.35 |
| 2 | 9 | −55.24 | 1.67 | −0.11 | −1.15 |
| 3 | 11 | 30.72 | 49.71 | 25.06 | −37.02 |

NUMERICAL EXAMPLE 20
UNIT: mm
SURFACE DATA

| Surface No. | r | d | nd | νd | Effective Diameter |
|---|---|---|---|---|---|
| 1 | 134.259 | 2.66 | 1.69169 | 57.0 | 75.16 |
| 2 | 33.812 | 1.03 | | | 55.39 |
| 3* | 30.495 | 3.00 | 1.49475 | 82.8 | 54.74 |
| 4* | 13.912 | 22.83 | | | 44.23 |
| 5 | −58.478 | 1.52 | 1.43875 | 94.7 | 43.62 |
| 6 | 43.347 | 1.00 | | | 40.16 |
| 7 | 50.904 | 7.86 | 2.00100 | 29.1 | 40.16 |
| 8 | −405.701 | (Variable) | | | 38.75 |
| 9 | −29.257 | 1.07 | 1.60342 | 38.0 | 27.87 |
| 10 | −133.737 | (Variable) | | | 27.47 |
| 11 | −255.803 | 2.93 | 1.84845 | 40.2 | 26.54 |
| 12 | −45.629 | 17.66 | | | 27.02 |
| 13 (SP) | ∞ | 6.37 | | | 30.94 |
| 14* | 24.762 | 9.53 | 1.49700 | 81.7 | 33.48 |
| 15* | −174.088 | 0.20 | | | 32.40 |
| 16 | 43.703 | 2.87 | 2.00103 | 29.1 | 29.88 |
| 17 | 99.803 | 4.07 | | | 28.94 |
| 18 | −261.548 | 1.00 | 1.72047 | 34.7 | 25.53 |
| 19 | 13.531 | 14.63 | 1.59282 | 68.6 | 21.54 |
| 20 | −17.689 | 2.87 | 1.92286 | 20.9 | 22.11 |
| 21 | −135.261 | 4.11 | | | 25.44 |
| 22* | −58.211 | 1.80 | 1.53110 | 55.9 | 27.69 |
| 23* | −52.296 | 1.70 | | | 30.11 |
| 24 | 192.856 | 8.10 | 1.94594 | 18.0 | 35.70 |
| 25 | −35.367 | 36.85 | | | |
| Image Plane | ∞ | | | | |

ASPHERIC DATA
3rd Surface
K = 0.00000e+00 A 4 = 1.00332e−05 A 6 = −3.66730e−07 A 8 = −2.09584e−10
A10 = 1.24792e−14
A 3 = −5.70248e−05 A 5 = 2.75890e−06 A 7 = 1.45422e−08
4th Surface
K = −7.05264e−01 A 4 = 3.20232e−05 A 6 = −6.31935e−08 A 8 = 6.80113e−10
A10 = −3.45033e−13
A 3 = −1.93535e−04 A 5 = 8.94102e−08 A 7 = −1.28612e−08
14th Surface
K = 0.00000e+00 A 4 = −6.81200e−07 A 6 = −6.40685e−09 A 8 = 7.27135e−12
15th Surface
K = 0.00000e+00 A 4 = 2.84618e−06 A 6 = −6.94354e−09 A 8 = 1.37661e−11
22nd Surface
K = 8.43642e+00 A 4 = −4.15102e−05 A 6 = 1.38203e−06 A 8 = 2.00911e−09
A 3 = 1.66027e−04 A 5 = −6.30721e−06 A 7 = −8.63597e−08
23rd Surface
K = 0.00000e+00 A 4 = −3.86620e−05 A 6 = 6.51115e−07 A 8 = 5.70924e−10
A 3 = 2.74896e−04 A 5 = −7.69110e−07 A 7 = −3.58567e−08

VARIOUS DATA

| | |
|---|---|
| Focal Length | 12.22 |
| Fno | 1.23 |
| Half Angle of View (°) | 60.54 |
| Image Height | 21.64 |
| Overall Lens Length | 149.65 |
| BF | 14.61 |

| Object Distance/Magnification | Infinity | 0.18Times |
|---|---|---|
| d 8 | 13.22 | 8.37 |
| d10 | 3.00 | 7.85 |
| Entrance Pupil Position | 24.65 | |
| Exit Pupil Position | 427.50 | |
| Front Principal-Point Position | 37.24 | |
| Rear Principal-Point Position | 2.39 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −41.53 | 39.90 | −2.15 | −42.59 |
| 2 | 9 | −62.30 | 1.07 | −0.19 | −0.86 |
| 3 | 11 | 55.88 | 77.84 | 88.26 | −83.36 |

NUMERICAL EXAMPLE 21
UNIT: mm
SURFACE DATA

| Surface No. | r | d | nd | νd | Effective Diameter |
|---|---|---|---|---|---|
| 1 | 33.851 | 1.80 | 1.80400 | 46.5 | 36.93 |
| 2 | 20.532 | 2.02 | | | 30.59 |
| 3* | 22.064 | 2.00 | 1.53110 | 55.9 | 29.51 |
| 4* | 9.976 | 9.12 | | | 22.31 |
| 5 | −60.282 | 1.30 | 1.49700 | 81.7 | 21.63 |
| 6 | 29.288 | 2.27 | | | 19.40 |
| 7 | 30.735 | 2.94 | 2.00100 | 29.1 | 18.38 |
| 8 | −687.163 | (Variable) | | | 17.55 |
| 9 | −24.358 | 0.95 | 1.52382 | 76.7 | 11.37 |
| 10 | 200.000 | 1.17 | 1.52368 | 52.1 | 10.44 |
| 11 | −183.913 | (Variable) | | | 9.86 |
| 12 (SP) | ∞ | 1.00 | | | 10.36 |
| 13 | 20.093 | 4.21 | 1.49700 | 81.7 | 10.88 |
| 14 | −53.152 | 0.57 | | | 10.90 |
| 15 | 24.081 | 1.94 | 1.91082 | 35.3 | 10.76 |
| 16 | 1944.710 | 0.90 | | | 10.94 |
| 17 | −88.604 | 4.07 | 1.72047 | 34.7 | 11.23 |
| 18 | 10.897 | 10.64 | 1.59282 | 68.6 | 13.08 |
| 19 | −11.216 | 1.00 | 1.92286 | 20.9 | 15.54 |
| 20 | −39.937 | 0.45 | | | 17.66 |
| 21* | 136.406 | 1.80 | 1.53110 | 55.9 | 17.99 |
| 22* | 43.529 | 3.86 | | | 21.05 |
| 23 | 133.165 | 5.23 | 1.94594 | 18.0 | 28.42 |
| 24 | −43.871 | 29.50 | | | |
| Image Plane | ∞ | | | | |

ASPHERIC DATA
3rd Surface
K = 0.00000e+00 A 4 = 2.71549e−05 A 6 = −7.22512e−08 A 8 = −4.23607e−10
A10 = 3.63131e−13
A 3 = −2.73761e−05 A 5 = −2.04306e−06 A 7 = 9.77488e−09
4th Surface
K = −5.01063e−01 A 4 = −2.04317e−05 A 6 = −1.11307e−06 A 8 = −8.64687e−10
A10 = −8.02651e−12
A 3 = 1.37514e−04 A 5 = 8.17815e−06 A 7 = 5.38890e−08
21st Surface
K = 1.34436e+02 A 4 = −2.44939e−04 A 6 = −1.28832e−06 A 8 = −5.30929e−09
A 3 = 5.47068e−05 A 5 = 8.31877e−06 A 7 = 1.13621e−07
22nd Surface
K = 0.00000e+00 A 4 = −1.00039e−04 A 6 = 4.73283e−07 A 8 = −1.42888e−09
A 3 = −3.12416e−05 A 5 = −4.57653e−06 A 7 = 2.77243e−08

VARIOUS DATA

| | |
|---|---|
| Focal Length | 15.06 |
| Fno | 3.00 |
| Half Angle of View (°) | 55.15 |
| Image Height | 21.64 |
| Overall Lens Length | 83.50 |
| BF | 15.21 |

| Object Distance/Magnification | Infinity | 0.12Times |
|---|---|---|
| d 8 | 7.03 | 4.11 |
| d11 | 2.00 | 4.92 |
| Entrance Pupil Position | 16.24 | |
| Exit Pupil Position | −47.65 | |
| Front Principal-Point Position | 27.70 | |
| Rear Principal-Point Position | 0.15 | |

LENS UNIT DATA

| Lens | Starting | Focal | Lens Configuration | Front Principal- | Rear Principal- |
|---|---|---|---|---|---|
| Unit | Surface | Length | Length | Point Position | Point Position |
| 1 | 1 | −41.76 | 21.45 | −3.49 | −27.22 |
| 2 | 9 | −53.84 | 2.12 | −0.21 | −1.61 |
| 3 | 12 | 21.45 | 35.68 | 11.05 | −24.86 |

FIGS. 2, 4, 6, 8, 10, 12, 14, 16, 18, 20, 22, 24, 26, 28, 30, 32, 34, 36, 38, 40, and 42 respectively illustrate the longitudinal aberrations (spherical aberration, astigmatism, distortion, and chromatic aberration) of the optical systems according to numerical examples 1 to 21 in the in-focus state at infinity. In each spherical aberration diagram, Fno denotes an F-number. A solid line denotes a spherical aberration amount for the d-line (with a wavelength 587.6 nm), and a broken line denotes a spherical aberration amount for the g-line (with a wavelength 435.8 nm). In each astigmatism diagram, a solid line S denotes an astigmatism amount in a sagittal image plane, and a broken line M denotes an astigmatism amount in a meridional image plane. Each distortion diagram denotes a distortion amount for the d-line. Each chromatic aberration diagram denotes a lateral chromatic aberration amount for the g-line. ω denotes a half angle of view (°).

Table 1 summarizes the values of inequalities (1) to (12) in each numerical example. The optical system according to each numerical example satisfies all of inequalities (1) to (12).

TABLE 1
Inequality

| | | (1) | (2) | (3) | (4) | (5) | (6) | (7) | (8) | (9) | (10) | (11) | (12) |
|---|---|---|---|---|---|---|---|---|---|---|---|---|---|
| NUMERICAL | 1 | 5.03 | 3.99 | −0.49 | −0.26 | 0.69 | 0.40 | 64.08 | 1.45 | 0.13 | −0.35 | 2.41 | 1.85 |
| EXAMPLE | 2 | 4.78 | 5.07 | −0.35 | −0.29 | 0.90 | 0.52 | 61.36 | 1.98 | 0.31 | −0.40 | 1.87 | 1.85 |
| | 3 | 3.57 | 2.83 | −0.49 | −0.06 | 0.61 | 0.40 | 55.67 | 1.95 | 0.24 | −0.40 | 1.07 | 1.85 |
| | 4 | 5.53 | 3.82 | −0.40 | −0.07 | 0.58 | 0.36 | 61.36 | 1.63 | 0.38 | −0.30 | 2.22 | 1.85 |
| | 5 | 6.50 | 4.31 | −0.53 | −0.16 | 0.21 | 0.39 | 61.36 | 2.17 | 0.26 | −0.33 | 2.50 | 1.85 |
| | 6 | 3.50 | 3.18 | −0.46 | −0.40 | 0.97 | 0.47 | 61.36 | 1.52 | 0.55 | −0.47 | 1.32 | 2.00 |
| | 7 | 5.09 | 4.80 | −0.45 | −0.30 | 0.92 | 0.48 | 61.36 | 2.04 | 0.39 | −0.39 | 1.88 | 1.85 |
| | 8 | 5.16 | 6.00 | −0.45 | −0.31 | 0.96 | 0.55 | 61.36 | 2.53 | 0.33 | −0.41 | 1.94 | 1.85 |
| | 9 | 5.21 | 6.90 | −0.47 | −0.32 | 0.96 | 0.58 | 61.36 | 2.75 | 0.30 | −0.42 | 1.99 | 1.85 |
| | 10 | 5.17 | 2.00 | −0.36 | −0.35 | 1.06 | 0.28 | 61.36 | 1.15 | 0.38 | −0.31 | 1.52 | 1.85 |
| | 11 | 5.31 | 1.51 | −0.31 | −0.31 | 1.08 | 0.18 | 61.36 | 0.92 | 0.40 | −0.23 | 1.38 | 1.85 |
| | 12 | 5.36 | 3.70 | −0.16 | −0.61 | 0.80 | 0.75 | 53.31 | 5.09 | 0.38 | −1.19 | 1.52 | 1.85 |
| | 13 | 5.25 | 6.90 | −0.32 | −0.55 | 8.77 | 0.80 | 58.55 | 6.28 | 0.27 | −0.98 | 1.69 | 1.85 |
| | 14 | 5.18 | 3.58 | −0.47 | −0.38 | 0.75 | 0.30 | 61.36 | 1.67 | 0.53 | −0.24 | 1.97 | 1.85 |
| | 15 | 5.40 | 2.55 | −0.50 | −0.40 | 0.64 | 0.10 | 61.36 | 1.13 | 0.55 | −0.09 | 2.02 | 1.85 |
| | 16 | 5.47 | 2.45 | −0.51 | −0.43 | 0.63 | 0.05 | 61.36 | 1.08 | 0.55 | −0.05 | 2.03 | 1.85 |
| | 17 | 5.46 | 3.54 | −0.37 | −0.35 | 1.08 | 0.38 | 66.86 | 1.71 | 0.33 | −0.33 | 1.86 | 1.85 |
| | 18 | 5.62 | 3.72 | 0.48 | −0.22 | 0.89 | 0.35 | 69.98 | 1.37 | 0.42 | −0.29 | 2.33 | 1.40 |
| | 19 | 5.43 | 3.43 | −0.42 | −0.43 | 0.81 | 0.29 | 51.04 | 1.22 | 0.40 | −0.23 | 1.91 | 1.85 |
| | 20 | 6.92 | 5.10 | −0.60 | −0.15 | 0.78 | 0.39 | 78.15 | 1.56 | 0.23 | −0.29 | 4.57 | 1.23 |
| | 21 | 3.86 | 3.09 | −0.24 | −0.35 | 0.91 | 0.38 | 61.36 | 1.31 | 0.43 | −0.36 | 1.39 | 3.00 |

### Image Pickup Apparatus

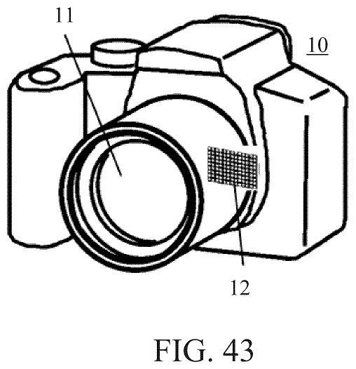

FIG. 43 illustrates a digital still camera as an image pickup apparatus using the optical system according to any one of the above examples as an imaging optical system.

Reference numeral 10 denotes a camera body, and reference numeral 11 denotes an imaging optical system that includes any of the optical systems according to Examples 1 to 21.

Reference numeral 12 denotes an image sensor (photoelectric conversion element) such as a CCD sensor or a CMOS sensor, which is built in the camera body 10 and captures an object image formed by the imaging optical system 11 (that is, the object through the imaging optical system 11).

Using the optical system according to Examples 1 to 21 as the imaging optical system 11 can provide a camera that has a reduced size, high-speed focusing ability, and high optical performance.

The camera body 10 may be a lens interchangeable type or a lens integrated type, and may also be a single-lens reflex type with a quick-return mirror, or a mirrorless type without a quick-return mirror.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-005868, filed on Jan. 16, 2025, which is hereby incorporated by reference herein in its entirety.

What is claimed is:

1. An optical system comprising, in order from an object side to an image side:
a front group with negative refractive power including at least one lens unit;
an intermediate lens unit with negative refractive power; and
a rear group with positive refractive power including at least one lens unit,
wherein each distance between adjacent lens units changes during focusing,
wherein the front group includes three negative lenses, consecutively arranged in this order from a position closest to an object in the front group to the image side,
wherein the intermediate lens unit moves toward the object side during focusing from infinity to a close distance,
wherein the front group includes at least two negative lenses and at least one positive lens, and
wherein the following inequalities are satisfied:
$$1. \leq TTL / ( f \times tan ω ) \leq 9.$$
$$0.5 \leq - fm / f \leq 9.0$$
where f is a focal length of the optical system, ω is a maximum half angle of view of the optical system, TTL is a distance on an optical axis from a lens surface closest to the object of the optical system to a lens surface closest to an image plane of the optical system plus an air-equivalent distance on the optical axis from the lens surface closest to the image plane of the optical system to the image plane, and fm is a focal length of the intermediate lens unit.

2. The optical system according to claim 1, wherein the front group includes a first negative lens disposed closest to the object, and
wherein the following inequality is satisfied:
$$- 1. \leq ( R 12 - R 11 ) / ( R 11 + R 12 ) < 0.0$$
where R11 is a radius of curvature of an object-side lens surface of the first negative lens, and R12 is a radius of curvature of an image-side lens surface of the first negative lens.

3. The optical system according to claim 1, wherein the front group includes:
a first negative lens disposed closest to the object, and
a second negative lens disposed on the image side of the first negative lens, and
wherein the following inequality is satisfied:
$$- 1. \leq ( R 21 + R 22 ) / ( R 22 - R 21 ) \leq 1.$$
where R21 is a radius of curvature of an object-side lens surface of the second negative lens, and R22 is a radius of curvature of an image-side lens surface of the second negative lens.

4. The optical system according to claim 1, wherein the following inequality is satisfied:
$$- 1. \leq ( Rp 1 + Rp 2 ) / ( Rp 2 - Rp 1 ) \leq 30.0$$
where Rp1 is a radius of curvature of an object-side lens surface of the positive lens in the front group, and Rp2 is a radius of curvature of an image-side lens surface of the positive lens.

5. The optical system according to claim 1, wherein the following inequality is satisfied:
$$0. < β m \leq 1.$$
where βm is a lateral magnification of the intermediate lens unit in an in-focus state on an object at infinity.

6. The optical system according to claim 1, wherein the following inequality is satisfied:
$$40 \leq vdn \leq 90$$
where νdn is an average value of the Abbe numbers based on d-line of all the negative lenses included in the front group.

7. The optical system according to claim 1, wherein the following inequality is satisfied:
$$0.5 \leq ( Rm 1 + Rm 2 ) / ( Rm 2 - Rm 1 ) \leq 30.0$$
where Rm1 is a radius of curvature of a lens surface closest to the object of the intermediate lens unit, and Rm2 is a radius of curvature of a lens surface closest to the image plane of the intermediate lens unit.

8. The optical system according to claim 1, wherein the following inequality is satisfied:
$$0.01 \leq Dm / Df \leq 1.$$
where Df is a distance on the optical axis between a lens surface closest to the image plane of the front group and a lens surface closest to the object of the intermediate lens unit in an in-focus state on an object at infinity, and Dm is a distance on the optical axis between a lens surface closest to the image plane of the intermediate lens unit and a lens surface closest to the object of the rear group in the in-focus state on the object at infinity.

9. The optical system according to claim 1, wherein the following inequality is satisfied:
$$- 2.00 \leq f / ff \leq - 0.01$$
where ff is a focal length of the front group.

10. The optical system according to claim 1, wherein the following inequality is satisfied:
$$0.1 \leq fr / f \leq 6.0$$
where fr is a focal length of the rear group.

11. The optical system according to claim 1, wherein the following inequality is satisfied:
$$0.9 \leq Fno \leq 5.6$$
where Fno is a minimum F-number of the optical system in an in-focus state on an object at infinity.

12. The optical system according to claim 1, wherein the front group includes a first lens unit with negative refractive power disposed closest to the object, and the first lens unit is fixed during focusing.

13. The optical system according to claim 1, wherein the rear group includes a lens with positive refractive power disposed closest to the image plane.

14. The optical system according to claim 1, wherein the intermediate lens unit consists of a single negative lens or a single cemented lens consisting of a negative lens and a positive lens.

15. The optical system according to claim 1, wherein the front group consists of, in order from the object side to the image side, a first negative lens, a negative lens, and a lens unit that consists of a second negative lens and a positive lens.

16. The optical system according to claim 1, wherein the front group consists of, in order from the object side to the image side, a first negative lens, a negative lens, a negative lens, and a lens unit that consists of a positive lens and a second negative lens.

17. The optical system according to claim 1, wherein the front group consists of, in order from the object side to the image side, a first lens unit consisting of a first negative lens, a second lens unit consisting of a negative lens, and a third lens unit consisting of a second negative lens and a positive lens, and
wherein the second lens unit moves during focusing.

18. The optical system according to claim 1, comprising:
a first lens unit as the front group;
a second lens unit as the intermediate lens unit; and
a third lens unit, a fourth lens unit, and a fifth lens unit that constitute the rear group,
wherein the fourth lens unit moves during focusing.

19. An image pickup apparatus comprising:
the optical system; and
an image sensor configured to capture an image of an object through the optical system,
wherein the optical system includes, in order from an object side to an image side:
a front group with negative refractive power including at least one lens unit,
an intermediate lens unit with negative refractive power, and
a rear group with positive refractive power including at least one lens unit,
wherein each distance between adjacent lens units changes during focusing,
wherein the front group includes three negative lenses, consecutively arranged in this order from a position closest to an object in the front group to the image side,
wherein the intermediate lens unit moves toward the object side during focusing from infinity to a close distance,
wherein the front group includes at least two negative lenses and at least one positive lens, and
wherein the following inequalities are satisfied:
$$1. \leq TTL / ( f \times tan ω ) \leq 9.0$$
$$0.5 \leq - fm / f \leq 9.0$$
where f is a focal length of the optical system, ω is a maximum half angle of view of the optical system, TTL is a distance on an optical axis from a lens surface closest to an object of the optical system to a lens surface closest to an image plane of the optical system plus an air-equivalent distance on the optical axis from the lens surface closest to the image plane of the optical system to the image plane, and fm is a focal length of the intermediate lens unit.
